(19) United States
(12) Patent Application Publication
(10) Pub. No.: US 2025/0216246 A1
(43) Pub. Date: Jul. 3, 2025

(54) FUEL LEVEL SENSORS FOR HOPPERS OF PELLET GRILLS

(71) Applicant: Weber-Stephen Products LLC, Palatine, IL (US)

(72) Inventor: Gregory J. Dykes, Elmhurst, IL (US)

(21) Appl. No.: 18/403,596

(22) Filed: Jan. 3, 2024

(51) Int. Cl. G01F 23/292; F24B 13/04

(52) U.S. Cl. CPC G01F 23/292; F24B 13/04

(57) ABSTRACT

Fuel level sensors for hoppers of pellet grills are disclosed. An example pellet grill includes a hopper, a fuel level sensor, and a cover. The fuel level sensor includes a transmission portion configured to transmit infrared light toward pellet fuel located within a pellet fuel storage compartment of the hopper, and a detection portion configured to receive infrared light reflected from the pellet fuel. The cover includes a first lens, a second lens, and a divider. The divider is located between the first lens and the second lens. The divider has a first side and a second side located opposite the first side. Infrared light transmitted from the transmission portion toward the pellet fuel passes through the first lens on the first side of the divider. Infrared light reflected from the pellet fuel toward the detection portion passes through the second lens on the second side of the divider.

### FIELD OF THE DISCLOSURE

This disclosure relates generally to pellet grills and, more specifically, to fuel level sensors for hoppers of pellet grills.

### BACKGROUND

Pellet grills are electronically-controlled cooking devices that are configured to cook (e.g., smoke, grill, bake, roast, broil, sear, and/or otherwise heat) food items located within (e.g., placed on one or more cooking grate(s) positioned within) a cooking chamber of the pellet grill. The controllable electronic components of the pellet grill can be powered via AC power (e.g., supplied to the pellet grill via household electricity or wall power) or DC power (e.g., supplied via an on-board or connected battery and/or DC power supply).

Conventional pellet grills store a volume of combustible pellet fuel (e.g., wood or charcoal pellets) in a hopper that is mounted and/or coupled to the pellet grill. A motor-driven auger in communication with an exit opening of the hopper feeds and/or supplies the pellet fuel from the hopper into a burn pot of the pellet grill in a controlled and/or automated manner. The speed, rate, and/or duty cycle of the auger is typically based on a user-selected temperature (e.g., a temperature setpoint) that is established and/or desired for the cooking chamber of the pellet grill. Pellet fuel that is deposited in the burn pot can initially be ignited via an ignitor (e.g., a DC-powered glow plug) of the pellet grill.

Combustion and/or burning of the pellet fuel within the burn pot produces, generates, and/or outputs heat which is subsequently distributed throughout the cooking chamber in a manner that causes the food items located within the cooking chamber to gradually become cooked. A motor-driven fan is typically implemented to assist with combusting the pellet fuel, and/or to assist with distributing and/or circulating heat (e.g., as may be produced by the combusted pellet fuel) throughout the cooking chamber.

Successful use of a pellet grill typically requires that the level and/or amount of pellet fuel contained in the hopper be checked and/or monitored from time to time to ensure that a sufficient volume of pellet fuel remains to the hopper to enable completion of one or more cooking operation(s) of the pellet grill. Inspection of the level and/or amount of pellet fuel remaining in the hopper is often performed manually (e.g., when a user of the pellet grill lifts a lid of the hopper and looks inside). Some pellet grills are equipped with a fuel level sensor that automatically senses, measures, and/or detects the level and/or amount of pellet fuel remaining in the hopper. In such examples, the fuel level sensor is typically located in and/or otherwise exposed to the interior of the pellet fuel storage compartment of the hopper. The interior of the pellet fuel storage compartment is a dusty environment that presents challenges with regard to the accuracy and/or the reliability of the fuel level sensor. For example, particulate (e.g., dust) associated with pellet fuel located in the pellet fuel storage compartment frequently clings to and/or builds up on the fuel level sensor (e.g., either on the fuel level sensor itself, or on a cover placed over the fuel level sensor). The accumulation of such particulate can lead to crosstalk between the transmission portion and the detection portion of the fuel level sensor, which in turn can lead to erroneous, skewed, inaccurate, and/or unreliable fuel level detections and/or determinations by the fuel level sensor. Accordingly, the ability to accurately detect the fuel level associated with such fuel level sensors is less than ideal.

### BRIEF DESCRIPTION OF THE DRAWINGS

FIG. 1 is a block diagram of an example pellet grill constructed in accordance with the teachings of this disclosure.

FIG. 2 is perspective view of an example implementation of the pellet grill of FIG. 1.

FIG. 3 is a partial cutaway view of the pellet grill of FIG. 2.

FIG. 4 is a perspective view of the hopper of the pellet grill of FIGS. 2 and 3, with the hopper shown in isolation.

FIG. 5 is a top view of the hopper of FIG. 4, with the lid of the hopper omitted.

FIG. 6 is a cross-sectional view of the hopper of FIGS. 4 and 5 taken along section A-A of FIG. 6.

FIG. 7 is a perspective view of an example cover for the fuel level sensor of FIG. 1, as implemented in the hopper of FIGS. 2-6.

FIG. 8 is a top view of the cover of FIG. 7.

FIG. 9 is a cross-sectional view of the cover of FIGS. 7 and 8 taken along section B-B of FIG. 8.

FIG. 10 is a cross-sectional view of the cover of FIGS. 7-9 taken along section B-B of FIG. 8, showing the cover positioned over an example implementation of the fuel level sensor of FIG. 1.

FIG. 11 is an example printed circuit board assembly implemented in the hopper of FIGS. 2-6.

FIG. 12 is a cross-sectional view of the printed circuit board assembly of FIG. 11 taken along section C-C of FIG. 11, showing the fuel level sensor and the cover positioned on the printed circuit board, with the cover shown covering the fuel level sensor.

FIG. 13 is a flowchart representative of example machine-readable instructions and/or example operations that may be executed by processor circuitry to implement a first fuel level sensor control process via the pellet grill of FIG. 1.

FIG. 14 is a flowchart representative of example machine-readable instructions and/or example operations that may be executed by processor circuitry to implement a second fuel level sensor control process via the pellet grill of FIG. 1.

FIG. 15 is a flowchart representative of example machine-readable instructions and/or example operations that may be executed by processor circuitry to implement a third fuel level sensor control process via the pellet grill of FIG. 1.

FIG. 16 is a flowchart representative of example machine-readable instructions and/or example operations that may be executed by processor circuitry to implement a fourth fuel level sensor control process via the pellet grill of FIG. 1.

FIG. 17 is a flowchart representative of example machine-readable instructions and/or example operations that may be executed by processor circuitry to implement a first fuel level sensor activation subroutine via the pellet grill of FIG. 1.

FIG. 18 is a flowchart representative of example machine-readable instructions and/or example operations that may be executed by processor circuitry to implement a second fuel level sensor activation subroutine via the pellet grill of FIG. 1.

FIG. 19 is a block diagram of an example processor platform including processor circuitry structured to execute and/or instantiate the machine-readable instructions and/or operations of FIGS. 13-18 to implement the pellet grill of FIG. 1.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

As discussed above, some known pellet grills are equipped with a fuel level sensor that automatically senses, measures, and/or detects the level and/or amount of pellet fuel remaining in the hopper of the pellet grill. The fuel level sensor is typically located in and/or otherwise exposed to the interior of the pellet fuel storage compartment of the hopper. The interior of the pellet fuel storage compartment is a dusty environment that presents challenges with regard to the accuracy and/or the reliability of the fuel level sensor. For example, particulate (e.g., dust) associated with pellet fuel located in the pellet fuel storage compartment frequently clings to and/or builds up on the fuel level sensor (e.g., either on the fuel level sensor itself, or on a cover placed over the fuel level sensor). The accumulation of such particulate can lead to crosstalk between the transmission portion and the detection portion of the fuel level sensor, which in turn can lead to erroneous, skewed, inaccurate, and/or unreliable fuel level detections and/or determinations by the fuel level sensor. Accordingly, the ability to accurately detect the fuel level associated with such fuel level sensors is less than ideal. Known solutions to the aforementioned challenges include frequent user intervention (e.g., a user having to routinely and manually wipe the accumulated dust off of the fuel level sensor itself, or off of a cover placed over the fuel level sensor) and fuel level detection system recalibrations, neither of which are desirable from a user experience standpoint. In addition to being inconvenient, frequently wiping the fuel level sensor and/or a cover placed over the fuel level sensor commonly leads to the formation of wear marks (e.g., scratches, scuffs, and/or other imperfections) on the fuel level sensor and/or the cover. Such wear marks further increase crosstalk between the transmission portion and the detection portion of the fuel level sensor.

Unlike the known pellet grills described above, example pellet grills disclosed herein include a controllable (e.g., automated) fuel level sensor located within the interior of the hopper of the pellet grill, with the fuel level sensor being covered (e.g., by a cover or casing) in a manner that, in addition to shielding the fuel level sensor from particulate (e.g., pellet fuel dust) and/or wear (e.g., scratches, scuffs, etc.), also advantageously (1) reduces instances of crosstalk associated with the transmission and detection portions of the fuel level sensor, (2) enhances the accuracy of the fuel level sensor, and (3) extends the usable life of the fuel level sensor and/or the associated cover thereof.

In some disclosed examples, the pellet grill includes a hopper, a fuel level sensor, and a cover. The hopper includes a pellet fuel storage compartment. In some disclosed examples, the fuel level sensor includes a transmission portion (e.g., an infrared transmitter, such as an infrared laser) and a detection portion (e.g., an infrared receiver). The transmission portion is configured to transmit infrared light toward pellet fuel located within the pellet fuel storage compartment. The detection portion is configured to receive infrared light reflected from the pellet fuel toward the detection portion. In some disclosed examples, the cover includes a first lens, a second lens, and a divider. The first lens and the second lens are located between the fuel level sensor and the pellet fuel. The first lens and the second lens advantageously shield the fuel level sensor from particulate (e.g., pellet fuel dust) and/or wear (e.g., scratches, scuffs, etc.), thereby eliminating the need to keep the fuel level sensor itself clean. The divider has a first side and a second side located opposite the first side. Infrared light transmitted from the transmission portion toward the pellet fuel passes through the first lens on the first side of the divider. Infrared light reflected from the pellet fuel toward the detection portion passes through the second lens on the second side of the divider. The divider advantageously reduces crosstalk associated with infrared light transmitted from the transmission portion, thereby enhancing the accuracy of the fuel level sensor. The reduction in crosstalk advantageously reduces (e.g., minimizes or eliminates) the need for user intervention associated with the cover (e.g., a user having to routinely wipe accumulated dust off of the cover), which in turn reduces instances of wear mark formation on the cover. The usable life of the fuel level sensor and/or the cover is accordingly extended.

In some disclosed examples, the transmission portion of the fuel level sensor is located on the first side of the divider, and the detection portion of the fuel level sensor is located on the second side of the divider. In some disclosed examples, the cover further includes a first compartment located on the first side of the divider, and a second compartment located on the second side of the divider. In some disclosed examples, the transmission portion of the fuel level sensor is aligned with the first compartment, and the detection portion of the fuel level sensor is aligned with the second compartment.

In some disclosed examples, the pellet grill further includes a printed circuit board assembly (PCBA), with the PCBA including a printed circuit board (PCB), the fuel level sensor, and the cover. In some disclosed examples, the fuel level sensor is positioned between the PCB and one or more of the first lens and the second lens of the cover. In some disclosed examples, the PCBA is located along an interior wall that defines the pellet fuel storage compartment of the hopper.

In some disclosed examples, the pellet grill further includes a controller configured to determine a fuel level of the pellet fuel based on the timing (e.g., time of travel) and/or the amount (e.g., quantity) of infrared light received at the detection portion of the fuel level sensor. In some disclosed examples, the controller is further configured to cause a notification associated with the determined fuel level to be presented locally (e.g., at a user interface of the pellet grill) or remotely (e.g., at a remote device via transmission from a network interface of the pellet grill). In some disclosed examples, the controller is further configured to evaluate whether the determined fuel level of the pellet fuel is below a fuel level threshold and, in response to detecting that the determined fuel level is below the fuel level threshold, to cause a notification associated with the determined fuel level or the fuel level threshold to be presented locally (e.g., at a user interface of the pellet grill) or remotely (e.g., at a remote device via transmission from a network interface of the pellet grill).

In some disclosed examples, the controller is further configured to activate the fuel level sensor in response to detecting an occurrence of an activation triggering event. In some disclosed examples, detecting the occurrence of the activation triggering event includes: (1) determining that a control system of the pellet grill is in an ON state or that the control system has initiated a startup sequence; (2) determining that a switch of the pellet grill is in an ON state; and/or (3) determining that a fuel level sensor activation request has been received via a user interface or a network interface of the pellet grill. In some disclosed examples, the controller is further configured to deactivate the fuel level sensor in response to detecting an occurrence of a deactivation triggering event. In some disclosed examples, detecting the occurrence of the deactivation triggering event includes: (1) determining that a control system of the pellet grill is in an OFF state or that the control system has initiated a shutdown sequence; (2) determining that a switch of the pellet grill is in an OFF state; and/or (3) determining that a fuel level sensor deactivation request has been received via a user interface or a network interface of the pellet grill.

The above-identified features as well as other advantageous features of example fuel level sensors for hoppers of pellet grills disclosed herein are further described below in connection with the figures of the application.

As used herein in a mechanical context, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part. As used herein in an electrical and/or computing context, the term “configured” means arranged, structured, and/or programmed. For example, in the context of processor circuitry configured to perform a specified operation, the processor circuitry is arranged, structured, and/or programmed (e.g., based on machine-readable instructions) to perform the specified operation.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, the phrase “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuit(s) structured to perform one or more specific operation(s), and/or (ii) one or more general purpose electrical circuit(s) programmable with instructions to perform one or more specific operation(s). Example processor circuitry described herein can include any type(s) and/or any number(s) of processor(s), microprocessor(s), controller(s), microcontroller(s), application specific integrated circuit(s) (ASIC(s)), programmable logic device(s) (PLD(s)), field programmable logic device(s), (FPLD(s)), field programmable gate arrays (FPGA(s)), digital signal processor(s) (DSP(s)), graphics processing unit(s) (GPU(s)), central processor unit(s) (CPU(s)), semiconductor-based (e.g., silicon-based) circuit(s), digital circuit(s), analog circuit(s), logic circuit(s), and/or integrated circuit(s) implemented via any type(s) and/or any number(s) of transistor(s), capacitor(s), diode(s), inductor(s), resistor(s), timer(s), counter(s), printed circuit board(s), connector(s), wire(s), and/or other electrical circuit component(s).

As used herein, the terms “non-transitory computer-readable medium” and “non-transitory computer-readable storage medium” are expressly defined to include any type of computer-readable storage device and/or storage disk and to exclude propagating signals and to exclude transmission media.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

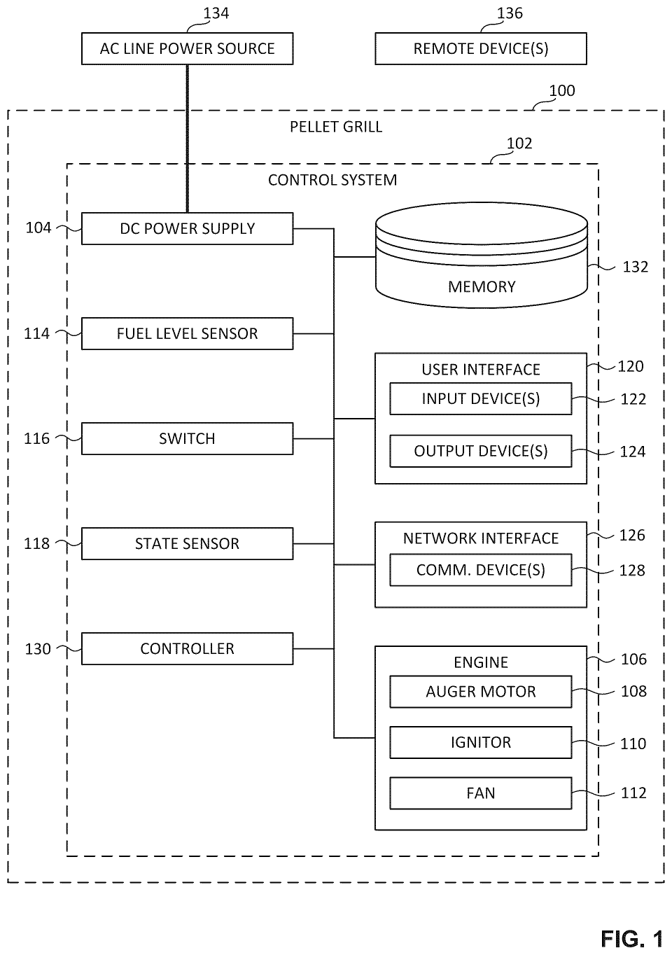

FIG. 1 is a block diagram of an example pellet grill 100 constructed in accordance with the teachings of this disclosure. The pellet grill 100 of FIG. 1 includes an example control system 102 configured to control manage, perform, carry out, and/or otherwise implement one or more operation(s) of the pellet grill 100 including, for example, for implementing one or more fuel level sensor operation(s), protocol(s), and/or process(es). In the illustrated example of FIG. 1, the control system 102 and/or, more generally, the pellet grill 100 includes an example DC power supply 104, an example engine 106 (e.g., including an example auger motor 108, an example ignitor 110, and an example fan 112), an example fuel level sensor 114, an example switch 116, an example state sensor 118, an example user interface 120 (e.g., including one or more example input device(s) 122 and one or more example output device(s) 124), an example network interface 126 (e.g., including one or more example communication device(s) 128), an example controller 130, and example memory 132. In other examples, one or more of the aforementioned components of FIG. 1 can be omitted from the control system 102 of the pellet grill 100. In still other examples, the control system 102 of the pellet grill 100 can include one or more other component(s) in addition to or in lieu of the aforementioned components of FIG. 1. The pellet grill 100 of FIG. 1 is configured to communicate (e.g., wirelessly communicate) with one or more example remote device(s) 136, as further described below.

The DC power supply 104 of FIG. 1 receives AC power from an example AC line power source 134 (e.g., a wall outlet) to which the DC power supply 104 and/or, more generally, the control system 102 of the pellet grill 100 is electrically connected. The DC power supply 104 converts AC power received from the AC line power source 134 into DC power that can thereafter be supplied to one or more of the engine 106 (e.g., including the auger motor 108, the ignitor 110, and the fan 112), the fuel level sensor 114, the switch 116, the state sensor 118, the user interface 120 (e.g., including the input device(s) 122 and the output device(s) 124), the network interface 126 (e.g., including the communication device(s) 128), the controller 130, and/or the memory 132. In some examples, the distribution of DC power from the DC power supply 104 to any of the aforementioned components of the control system 102 can be controlled and/or managed by the switch 116, the user interface 120, and/or the controller 130. In other examples, the DC power supply 104 of FIG. 1 can alternatively be implemented by a battery (or a plurality of batteries) dedicated to powering one or more of the aforementioned component(s) of the control system 102 of the pellet grill 100 (e.g., the fuel level sensor 114 of the control system 102).

The engine 106 of FIG. 1 facilitates the performance of one or more cooking operation(s) within a cooking chamber of the pellet grill 100. In the illustrated example of FIG. 1, the engine 106 includes the auger motor 108, the ignitor 110, and the fan 112. The auger motor 108 of the engine 106 controls and/or facilitates the delivery of pellet fuel from a hopper of the pellet grill 100 into a burn pot of the pellet grill 100. In some examples, the auger motor 108 of the engine 106 is implemented as a DC-powered, variable speed motor. The ignitor 110 of the engine 106 controls and/or facilitates the ignition of pellet fuel located within the burn pot of the pellet grill 100. In some examples, the ignitor 110 of the engine 106 is implemented as a DC-powered glow plug. The fan 112 of the engine 106 controls and/or facilitates delivery of an airflow to the pellet fuel located within the burn pot of the pellet grill 100 to control the rate of combustion of such pellet fuel. In some examples, the fan 112 of the engine 106 is implemented as a DC-powered, variable speed fan.

The fuel level sensor 114 of FIG. 1 senses, measures and/or detects the level or amount of pellet fuel present in a pellet fuel storage compartment of a hopper of the pellet grill 100. In the illustrated example of FIG. 1, the fuel level sensor 114 is operatively coupled to (e.g., in electrical communication with) the switch 116, the controller 130, and/or the memory 132 of the control system 102 of the pellet grill 100. In the illustrated example of FIG. 1, the fuel level sensor 114 is implemented by and/or as an infrared sensor (e.g., a time-of-flight sensor) having a transmission portion (e.g., an infrared transmitter, such as an infrared laser) and a detection portion (e.g., an infrared receiver). The fuel level sensor 114 of FIG. 1 is mounted to, positioned in, extends into, and/or is directed toward the pellet fuel storage compartment of the hopper of the pellet grill 100, as further described below. Infrared light generated by the transmission portion of the fuel level sensor 114 is projected toward pellet fuel contained in the pellet fuel storage compartment of the hopper. The projected infrared light reflects off of the pellet fuel and is directed back toward the detection portion of the fuel level sensor 114. Data and/or signals sensed, measured, and/or detected by the fuel level sensor 114 of FIG. 1 may be of any quantity, type, form and/or format. Data, information, and/or signals sensed, measured, and/or detected by the fuel level sensor 114 of FIG. 1 can be transmitted directly to the controller 130 of FIG. 1, and/or can be transmitted to and stored in a computer-readable storage medium such as the memory 132 of FIG. 1.

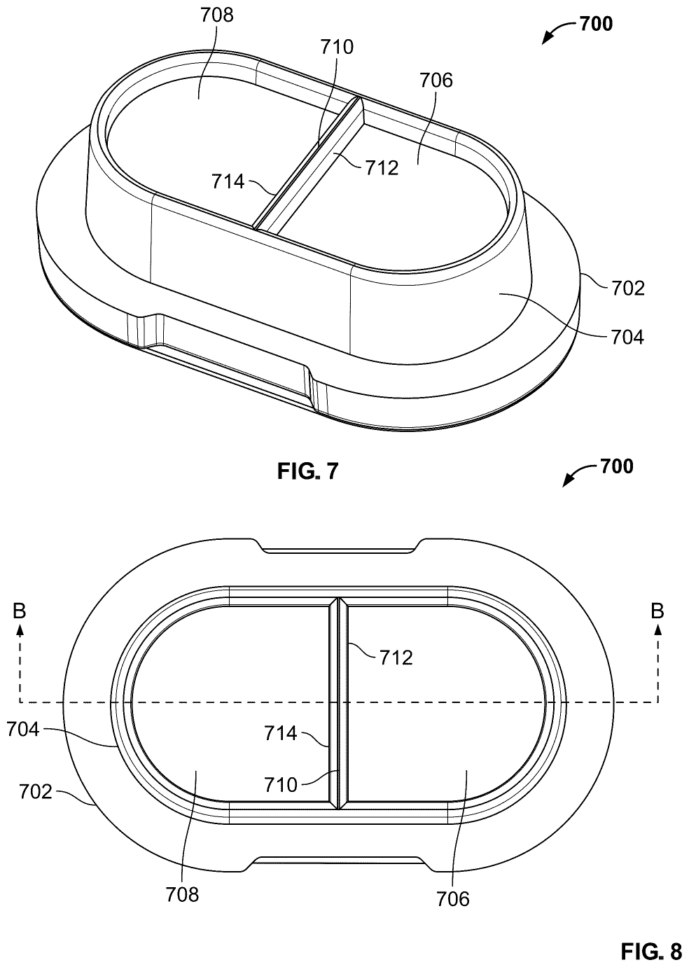

In some examples, the fuel level sensor 114 of FIG. 1 is protected (e.g., shielded or covered) by a cover that includes a first lens, a second lens, and a divider. The first lens and the second lens of the cover are positioned between the fuel level sensor 114 and the pellet fuel located in the pellet fuel storage compartment of the hopper. The first lens and the second lens of the cover are advantageously configured to shield the fuel level sensor 114 from particulate (e.g., pellet fuel dust) and/or wear (e.g., scratches, scuffs, etc.). The divider of the cover has a first side and a second side located opposite the first side. The divider of the cover is advantageously configured to reduce crosstalk associated with infrared light transmitted from the transmission portion of the fuel level sensor 114. In this regard, infrared light transmitted from the transmission portion of the fuel level sensor 114 toward the pellet fuel passes through the first lens of the cover on the first side of the divider. By contrast, infrared light reflected from the pellet fuel toward the detection portion of the fuel level sensor 114 passes through the second lens of the cover on the second side of the divider. An example cover to be implemented with the fuel level sensor 114 of FIG. 1 is further described below in connection with FIGS. 7-12

The switch 116 of FIG. 1 is operable by a user of the pellet grill 100 to control the fuel level sensor 114 and/or, more generally, the control system 102 of the pellet grill 100. More specifically, the switch 116 of FIG. 1 is operable by a user of the pellet grill 100 to control the activation and deactivation of the fuel level sensor 114 of the pellet grill 100. In the illustrated example of FIG. 1, the switch 116 is operatively coupled to (e.g., in electrical communication with) the fuel level sensor 114, the controller 130, and/or the memory 132 of the control system 102 of the pellet grill 100. In some examples, the switch 116 is mounted on and/or to a hopper of the pellet grill 100. In other examples, the switch 116 can be mounted on and/or to a different structure of the pellet grill 100 (e.g., a frame or a side table of the pellet grill 100). In still other examples, the switch 116 can be fully integrated as part of the user interface 120 of the pellet grill 100.

The switch 116 of FIG. 1 includes an actuatable component (e.g., a button) that is actuatable by a user of the pellet grill 100 to selectively cause the switch 116 to close a circuit of the fuel level sensor 114 and/or the control system 102 of the pellet grill 100. When the switch 116 closes the circuit (e.g., in response to a user actuating the actuatable component of the switch 116), power is transmitted from a power source (e.g., a power supply, a battery, etc.) to the fuel level sensor 114 of the control system 102, thereby enabling operation of the fuel level sensor 114. When the switch 116 opens the circuit (e.g., in response to a user releasing the actuatable component of the switch 116, or actuating the actuatable component of the switch 116 a second time), power is no longer transmitted from the power source to the fuel level sensor 114 of the control system 102, thereby disabling operation of the fuel level sensor 114. In some examples, the switch 116 of FIG. 1 is configured as an ON/OFF switch. In such examples, a user must press and/or actuate an actuatable component (e.g., a button) of the switch 116 two successive times to cycle the switch 116 and/or the circuit from an OFF state to an ON state and back to an OFF state (e.g., from an open circuit to a closed circuit, and from a closed circuit back to an open circuit).

The state sensor 118 of FIG. 1 senses and/or detects one or more state(s) (e.g., a power state, an operational state, etc.) of the switch 116, of the control system 102, and/or, more generally, of the pellet grill 100 of FIG. 1. For example, the state sensor 118 can sense and/or detect whether the control system 102 and/or, more generally, the pellet grill 100 is in a powered state (e.g., an ON state). Conversely, the state sensor 118 can also sense and/or detect whether the control system 102 and/or, more generally, the pellet grill 100 is in, or is in the process of transitioning into, an unpowered state (e.g., an OFF state). As another example, the state sensor 118 can sense and/or detect whether the control system 102 and/or, more generally, the pellet grill 100 has initiated and/or is executing a startup sequence (e.g., a sequence that powers on the pellet grill 100 and/or that causes an ignitor of the pellet grill 100 to be in an ON state). Conversely, the state sensor 118 can also sense and/or detect whether the control system 102 and/or, more generally, the pellet grill 100 has initiated and/or is executing a shutdown sequence (e.g., a sequence that causes an auger motor, an ignitor, a fan, and/or, more generally, the pellet grill 100 to be shut down and/or powered off). As yet another example, the state sensor 118 can sense and/or detect whether the switch 116 of FIG. 1 is closed and/or in a powered state (e.g., an ON state). Conversely, the state sensor 118 can also sense and/or detect whether the switch 116 of FIG. 1 is open and/or in an unpowered state (e.g., an OFF state). In the illustrated example of FIG. 1, the state sensor 118 is operatively coupled to (e.g., in electrical communication with) the switch 116, the controller 130, and/or the memory 132 of the control system 102 of the pellet grill 100. Data and/or signals sensed and/or detected by the state sensor 118 of FIG. 1 may be of any quantity, type, form and/or format. Data, information, and/or signals sensed and/or detected by the state sensor 118 of FIG. 1 can be transmitted directly to the controller 130 of FIG. 1, and/or can be transmitted to and stored in a computer-readable storage medium such as the memory 132 of FIG. 1.

The user interface 120 of FIG. 1 enables a user of the pellet grill 100 to interact with the controller 130 of the control system 102 of FIG. 1. In the illustrated example of FIG. 1, the user interface 120 is operatively coupled to (e.g., in electrical communication with) the controller 130 and/or the memory 132 of the control system 102 of the pellet grill 100. In some examples, the user interface 120 is mechanically coupled to (e.g., fixedly connected to) the pellet grill 100. For example, the user interface 120 can be mounted to a cookbox, a lid, a hopper, a frame, or a side table of the pellet grill 100. The user interface 120 is preferably mounted to a portion of the pellet grill 100 that is readily accessible to a user of the pellet grill 100, such as a front portion of a cookbox, a front portion of a lid, a front portion of a hopper, a front portion of a frame, or a front portion of a side table of the pellet grill 100. In some examples, respective ones of the input device(s) 122 and/or the output device(s) 124 of the user interface 120 can be mounted to different portions of the pellet grill 100. The architecture and/or operations of the user interface 120 can be distributed among any number of user interfaces respectively having any number of input device(s) 122 and/or output device(s) 124 located at and/or mounted to any portion of the pellet grill 100.

The input device(s) 122 of the user interface 120 of FIG. 1 permit(s) the user of the pellet grill 100 to enter data, information, selections, inputs, instructions, and/or commands into the controller 130. For example, the input device(s) 122 of the user interface 120 can permit the user of the pellet grill 100 to enter data, information, one or more selection(s), one or more input(s), one or more instruction(s), and/or one or more command(s) into the controller 130 that cause(s) the controller 130 to implement (e.g., to initiate, to execute, and/or to terminate) one or more fuel level sensor control process(es) (e.g., one or more process(es) and/or protocol(s) configured to control activation (e.g., powering on) or deactivation (e.g., powering off) of the fuel level sensor 114 of FIG. 1) via the control system 102 of the pellet grill 100. The input device(s) 122 of the user interface 120 can be implemented, for example, by one or more of a touchscreen, a button, a dial, a knob, a switch, an audio sensor, a microphone, an image sensor, a camera, and/or a voice recognition system.

The output device(s) 124 of the user interface 120 of FIG. 1 facilitate(s) the presentation of data and/or information (e.g., data and/or information generated by the controller 130) to the user of the pellet grill 100. For example, the output device(s) 124 of the user interface 120 can facilitate the presentation (e.g., textually, graphically, and/or audibly) of data and/or information associated with implementing (e.g., initiating, executing, and/or terminating) one or more fuel level sensor control process(es) (e.g., one or more process(es) and/or protocol(s) configured to control activation and/or deactivation of the fuel level sensor 114 of FIG. 1) via the control system 102 of the pellet grill 100. The output device(s) 124 of the user interface 120 can be implemented, for example, by one or more of a display device (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, and/or a speaker.

The network interface 126 of FIG. 1 enables a user of the pellet grill 100 to remotely interact (e.g., via one or more of the remote device(s) 144) with the control system 102 of the pellet grill 100. In the illustrated example of FIG. 1, the network interface 126 is operatively coupled to (e.g., in electrical communication with) the controller 130 and/or the memory 132 of the control system 102 of the pellet grill 100. The network interface 126 of FIG. 1 includes one or more communication device(s) 128 (e.g., transmitter(s), receiver(s), transceiver(s), modem(s), gateway(s), wireless access point(s), etc.) to facilitate the exchange of data with external machines (e.g., computing devices of any kind, including the remote device(s) 136 of FIG. 1) by a wired or wireless communication network. Communications transmitted and/or received via the communication device(s) 128 and/or, more generally, via the network interface 126 can be made over and/or carried by, for example, an Ethernet connection, a digital subscriber line (DSL) connection, a telephone line connection, a coaxial cable system, a satellite system, a wireless system, a cellular telephone system, an optical connection, etc.

The controller 130 of FIG. 1 implements processor circuitry to control and/or manage one or more operation(s) associated with the control system 102 of the pellet grill of FIG. 1 and/or the components thereof, including the DC power supply 104, the engine 106 (e.g., including the auger motor 108, the ignitor 110, and the fan 112), the fuel level sensor 114, the switch 116, the state sensor 118, the user interface 120 (e.g., including the input device(s) 122 and the output device(s) 124), the network interface 126 (e.g., including the communication device(s) 128), and/or the memory 132. The processor circuitry of the controller 130 of FIG. 1 includes any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s).

In the illustrated example of FIG. 1, the controller 130 is graphically represented as a single, discrete structure that manages and/or controls the operation(s) of various components of the control system 102 of the pellet grill 100. It is to be understood, however, that in other examples, the architecture and/or operations of the controller 130 can be distributed among any number of controllers, with each separate controller having a dedicated subset of one or more operation(s) described herein. In some examples, the control system 102 of the pellet grill 100 can include separate, distinct controllers for one or more of the DC power supply 104, the engine 106 (e.g., including the auger motor 108, the ignitor 110, and the fan 112), the fuel level sensor 114, the switch 116, the state sensor 118, the user interface 120 (e.g., including the input device(s) 122 and the output device(s) 124), the network interface 126 (e.g., including the communication device(s) 128), and/or the memory 132 of the control system 102 of the pellet grill 100.

In the illustrated example of FIG. 1, the controller 130 is operatively coupled to (e.g., in electrical communication with) one or more of the DC power supply 104, the engine 106 (e.g., including the auger motor 108, the ignitor 110, and the fan 112), the fuel level sensor 114, the switch 116, the state sensor 118, the user interface 120 (e.g., including the input device(s) 122 and the output device(s) 124), the network interface 126 (e.g., including the communication device(s) 128), and/or the memory 132 of the control system 102 of the pellet grill 100. The controller 130 of FIG. 1 is also operatively coupled to (e.g., in wired or wireless electrical communication with) the remote device(s) 136 of FIG. 1 via the network interface 126 (e.g., including the communication device(s) 128) of the control system 102 of the pellet grill 100 of FIG. 1. In some examples, the controller 130 of FIG. 1 receives commands, instructions, signals, and/or data from, and/or transmits commands, instructions, signals, and/or data to, the engine 106 (e.g., including the auger motor 108, the ignitor 110, and the fan 112), the fuel level sensor 114, the switch 116, the state sensor 118, the user interface 120 (e.g., including the input device(s) 122 and the output device(s) 124), the network interface 126 (e.g., including the communication device(s) 128), and/or the memory 132 of the control system 102 of the pellet grill 100 in connection with implementing (e.g., initiating, executing, and/or terminating) one or more fuel level sensor control process(es) and/or protocol(s), and/or one or more fuel level sensor activation subroutine(s) thereof.

In some examples, the controller 130 of FIG. 1 implements, manages, and/or controls a first fuel level sensor control process (e.g., a first fuel level sensor control protocol) that is based on (e.g., dependent on) power state data associated with the control system 102 of the pellet grill 100 of FIG. 1, as detected by the state sensor 118 of FIG. 1. When executing the first fuel level sensor control process, the controller 130 of FIG. 1 determines, based on data sensed, measured, and/or detected by the state sensor 118 of FIG. 1, whether the control system 102 of the pellet grill 100 of FIG. 1 is in a powered state (e.g., an ON state). If the controller 130 determines that the control system 102 of the pellet grill 100 is in a powered state (e.g., an ON state), the controller 130 commands, instructs, signals, and/or otherwise causes the fuel level sensor 114 of FIG. 1 to activate (e.g., to begin operating). The controller 130 accordingly treats the determination that the control system 102 of the pellet grill 100 is in a powered state (e.g., an ON state) as an activation triggering event with regard to the fuel level sensor 114. Various fuel level sensor activation subroutines that can be implemented by the controller 130 of FIG. 1 in connection with performing and/or executing the first fuel level sensor control process are further described below.

When executing the first fuel level sensor control process, the controller 130 of FIG. 1 also determines, based on data sensed, measured, and/or detected by the state sensor 118 of FIG. 1, whether the control system 102 of the pellet grill 100 of FIG. 1 is in, or in the process of being transitioned into, an unpowered state (e.g., an OFF state). If the controller 130 determines that the control system 102 of the pellet grill 100 is in, or in the process of being transitioned into, an unpowered state (e.g., an OFF state), the controller 130 commands, instructs, signals, and/or otherwise causes the fuel level sensor 114 of FIG. 1 to deactivate (e.g., to cease operating). The controller 130 accordingly treats the determination that the control system 102 of the pellet grill 100 is in, or in the process of being transitioned into, an unpowered state (e.g., an OFF state) as a deactivation triggering event with regard to the fuel level sensor 114.

In some examples, the controller 130 of FIG. 1 implements, manages, and/or controls a second fuel level sensor control process (e.g., a second fuel level sensor control protocol) that is based on (e.g., dependent on) operational state data associated with the control system 102 of the pellet grill 100 of FIG. 1, as detected by the state sensor 118 of FIG. 1. When executing the second fuel level sensor control process, the controller 130 of FIG. 1 determines, based on data sensed, measured, and/or detected by the state sensor 118 of FIG. 1, whether a startup sequence of the pellet grill 100 of FIG. 1 (e.g., a sequence that powers on the pellet grill 100 and/or that causes an ignitor of the pellet grill 100 to be in an ON state) has been initiated. If the controller 130 determines that a startup sequence of the pellet grill 100 has been initiated, the controller 130 commands, instructs, signals, and/or otherwise causes the fuel level sensor 114 of FIG. 1 to activate (e.g., to begin operating). The controller 130 accordingly treats the determination that a startup sequence of the pellet grill 100 has been initiated as an activation triggering event with regard to the fuel level sensor 114. Various fuel level sensor activation subroutines that can be implemented by the controller 130 of FIG. 1 in connection with performing and/or executing the second fuel level sensor control process are further described below.

When executing the second fuel level sensor control process, the controller 130 of FIG. 1 also determines, based on data sensed, measured, and/or detected by the state sensor 118 of FIG. 1, whether a shutdown sequence of the pellet grill 100 of FIG. 1 (e.g., a sequence that causes an auger motor, an ignitor, a fan, and/or, more generally, the pellet grill 100 to be shut down and/or powered off) has been initiated. If the controller 130 determines that a shutdown sequence of the pellet grill 100 has been initiated, the controller 130 commands, instructs, signals, and/or otherwise causes the fuel level sensor 114 of FIG. 1 to deactivate (e.g., to cease operating). The controller 130 accordingly treats the determination that a shutdown sequence of the pellet grill 100 has been initiated as a deactivation triggering event with regard to the fuel level sensor 114.

In some examples, the controller 130 of FIG. 1 implements, manages, and/or controls a third fuel level sensor control process (e.g., a third fuel level sensor control protocol) that is based on (e.g., dependent on) power state data associated with the switch 116 of the control system 102 of the pellet grill 100 of FIG. 1, as detected by the state sensor 118 of FIG. 1. When executing the third fuel level sensor control process, the controller 130 of FIG. 1 determines, based on data sensed, measured, and/or detected by the state sensor 118 of FIG. 1, whether the switch 116 of the pellet grill 100 of FIG. 1 is closed and/or in a powered state (e.g., an ON state). If the controller 130 determines that the switch 116 of the pellet grill 100 is closed and/or in a powered state (e.g., an ON state), the controller 130 commands, instructs, signals, and/or otherwise causes the fuel level sensor 114 of FIG. 1 to activate (e.g., to begin operation). The controller 130 accordingly treats the determination that the switch 116 of the pellet grill 100 is closed and/or in a powered state (e.g., an ON state) as an activation triggering event with regard to the fuel level sensor 114. Various fuel level sensor activation subroutines that can be implemented by the controller 130 of FIG. 1 in connection with performing and/or executing the third fuel level sensor control process are further described below.

When executing the third fuel level sensor control process, the controller 130 of FIG. 1 also determines, based on data sensed, measured, and/or detected by the state sensor 118 of FIG. 1, whether the switch 116 of the pellet grill 100 of FIG. 1 is open, and/or is in, or in the process of being transitioned into, an unpowered state (e.g., an OFF state). If the controller 130 determines that the switch 116 of the pellet grill 100 is open, and/or is in, or in the process of being transitioned into, an unpowered state (e.g., an OFF state), the controller 130 commands, instructs, signals, and/or otherwise causes the fuel level sensor 114 of FIG. 1 to deactivate (e.g., to cease operating). The controller 130 accordingly treats the determination that the switch 116 of the pellet grill 100 is open, and/or is in, or in the process of being transitioned into, an unpowered state (e.g., an OFF state) as a deactivation triggering event with regard to the fuel level sensor 114.

In some examples, the controller 130 of FIG. 1 implements, manages, and/or controls a fourth fuel level sensor control process (e.g., a fourth fuel level sensor control protocol) that is based on (e.g., dependent on) one or more fuel level sensor control request(s) received from the user interface 120 or the network interface 126 of the control system 102 of the pellet grill 100 of FIG. 1. When executing the fourth fuel level sensor control process, the controller 130 of FIG. 1 determines whether the user interface 120 and/or the network interface 126 of the control system 102 has/have received any commands, instructions, signals, inputs, and/or other data indicative of a request to activate the fuel level sensor 114 of the pellet grill 100. If the controller 130 determines that the user interface 120 and/or the network interface 126 of the control system 102 has/have received one or more command(s), instruction(s), signal(s), input(s), and/or other data indicative of a request to activate the fuel level sensor 114 of the pellet grill 100, the controller 130 commands, instructs, signals, and/or otherwise causes the fuel level sensor 114 of FIG. 1 to activate (e.g., to begin operating). The controller 130 accordingly treats the determination that the user interface 120 and/or the network interface 126 of the control system 102 has/have received one or more command(s), instruction(s), signal(s), input(s), and/or other data indicative of a request to activate the fuel level sensor 114 of the pellet grill 100 as an activation triggering event with regard to the fuel level sensor 114. Various fuel level sensor activation subroutines that can be implemented by the controller 130 of FIG. 1 in connection with performing and/or executing the fourth fuel level sensor control process are further described below.

When executing the fourth fuel level sensor control process, the controller 130 of FIG. 1 also determines whether the user interface 120 and/or the network interface 126 of the control system 102 has/have received any commands, instructions, signals, inputs, and/or other data indicative of a request to deactivate the fuel level sensor 114 of the pellet grill 100. If the controller 130 determines that the user interface 120 and/or the network interface 126 of the control system 102 has/have received one or more command(s), instruction(s), signal(s), input(s), and/or other data indicative of a request to deactivate the fuel level sensor 114 of the pellet grill 100, the controller 130 commands, instructs, signals, and/or otherwise causes the fuel level sensor 114 of FIG. 1 to deactivate (e.g., to cease operating). The controller 130 accordingly treats the determination that the user interface 120 and/or the network interface 126 of the control system 102 has/have received one or more command(s), instruction(s), signal(s), input(s), and/or other data indicative of a request to deactivate the fuel level sensor 114 of the pellet grill 100 as a deactivation triggering event with regard to the fuel level sensor 114.

For any of the various fuel level sensor control processes described above (e.g., the first fuel level sensor control process, the second fuel level sensor control process, the third fuel level sensor control process, an/or the fourth fuel level sensor control process), the controller 130 of FIG. 1 can also determine whether the user interface 120 and/or the network interface 126 of the control system 102 of FIG. 1 has/have received any commands, instructions, signals, inputs, and/or other data indicative of a request to terminate the fuel level sensor control process. If the controller 130 determines that the fuel level sensor control process is to continue (e.g., that no termination request has been received), the controller 130 continues implementing the fuel level sensor control process. If the controller 130 instead determines that the fuel level sensor control process is to cease or terminate (e.g., that a termination request has been received), the controller 130 terminates and/or stops execution of the fuel level sensor control process.

In some examples, the controller 130 of FIG. 1 implements, manages, and/or controls a first fuel level sensor activation subroutine. When executing the first fuel level sensor activation subroutine, the controller 130 of FIG. 1 instructs, commands, signals, and/or otherwise causes the fuel level sensor 114 of FIG. 1 to transmit infrared light toward pellet fuel located in a pellet fuel storage compartment of a hopper of the pellet grill 100 of FIG. 1. For example, a transmission portion of the fuel level sensor 114 (e.g., an infrared transmitter of a time-of-flight sensor) can transmit and/project infrared light from the fuel level sensor 114 toward pellet fuel (e.g., wood or charcoal pellets) located within the pellet fuel storage compartment of the hopper of the pellet grill. In some examples, the infrared light transmitted from the transmission portion of the fuel level sensor 114 toward the pellet fuel passes through a first lens of a cover of the fuel level sensor 114 before reaching the pellet fuel, with the transmitted infrared light passing through the first lens of the cover on a first side of a divider of the cover.

In connection with the first fuel level sensor activation subroutine, the fuel level sensor 114 of FIG. 1 receives infrared light reflected from the pellet fuel located in the pellet fuel storage compartment of the hopper of the pellet grill 100 of FIG. 1. For example, a detection portion of the fuel level sensor 114 (e.g., an infrared receiver of a time-of-flight sensor) can receive infrared light reflected from the pellet fuel (e.g., the wood or charcoal pellets) located within the pellet fuel storage compartment of the hopper of the pellet grill 100 back toward the detection portion. In some examples, the reflected infrared light passes through a second lens of the cover of the fuel level sensor 114 prior to being received at the detection portion of the fuel level sensor 114, with the reflected infrared light passing through the second lens of the cover on a second side of the divider of the cover located opposite the first side of the divider of the cover.

In connection with the first fuel level sensor activation subroutine, the controller 130 of FIG. 1 determines a level or an amount of pellet fuel present in the pellet fuel storage compartment of the hopper of the pellet grill 100 (referenced herein as the “fuel level”) based on the infrared light received at the fuel level sensor 114 of FIG. 1. For example, the controller 130 can determine the fuel level by accessing correlation data that identifies and/or otherwise indicates a fuel level corresponding to the sensed, measured, and/or detected timing (e.g., time of travel) and/or amount (e.g., quantity) of infrared light (e.g., reflected from the pellet fuel) received at the detection portion of the fuel level sensor 114.

In connection with the first fuel level sensor activation subroutine, the controller 130 of FIG. 1 instructs, commands, signals, and/or otherwise causes one or more notification(s) associated with the determined fuel level to be presented locally and/or remotely. For example, the controller 130 can instruct, command, signal, and/or otherwise cause the user interface 120 of the pellet grill 100 of FIG. 1 to locally present (e.g., via one or more of the output device(s) 124 of the user interface 120) one or more notification(s) identifying and/or otherwise indicating the determined fuel level. As another example, the controller 130 can additionally or alternatively instruct, command, signal, and/or otherwise cause the network interface 126 of the pellet grill 100 of FIG. 1 to transmit (e.g., via one or more of the communication device(s) 128 of the network interface 126) one or more notification(s) identifying and/or otherwise indicating the determined fuel level to one or more of the remote device(s) 136 of FIG. 1 for remote presentation via one or more of the output device(s) of the remote device(s) 136. In some examples, one or more of the notification(s) identifying and/or otherwise indicating the determined fuel level of the pellet grill 100 can be expressed (e.g., textually, graphically, visually, and/or audibly represented) as a percentage of a maximum capacity (e.g., the fuel level is at 80% of the maximum capacity, the fuel level is 50% of the maximum capacity, etc.). In other examples, one or more of the notification(s) identifying and/or otherwise indicating the determined fuel level of the pellet grill 100 can be expressed (e.g., textually, graphically, visually, and/or audibly represented) in more relative and/or more general terms (e.g., the fuel level is high, the fuel level is low, etc.).

In some examples, the controller 130 of FIG. 1 implements the first fuel level sensor activation subroutine as a looped control function or subroutine, with such implementation continuing until a deactivation triggering event detected by the control system 102 of the pellet grill 100 dictates otherwise (e.g., detection of the control system 102 of the pellet grill 100 being in or transitioning into an OFF state, detection of the control system 102 of the pellet grill 100 initiating a shutdown sequence, detection of the switch 116 of the pellet grill 100 being in or transitioning into an OFF state, detection that the control system 102 of the pellet grill 100 has received a deactivation request associated with the fuel level sensor 114, etc.).

In some examples, the controller 130 of FIG. 1 implements, manages, and/or controls a second fuel level sensor activation subroutine. When executing the second fuel level sensor activation subroutine, the controller 130 of FIG. 1 instructs, commands, signals, and/or otherwise causes the fuel level sensor 114 of FIG. 1 to transmit infrared light toward pellet fuel located in a pellet fuel storage compartment of a hopper of the pellet grill 100 of FIG. 1. For example, a transmission portion of the fuel level sensor 114 (e.g., an infrared transmitter of a time-of-flight sensor) can transmit and/project infrared light from the fuel level sensor 114 toward pellet fuel (e.g., wood or charcoal pellets) located within the pellet fuel storage compartment of the hopper of the pellet grill. In some examples, the infrared light transmitted from the transmission portion of the fuel level sensor 114 toward the pellet fuel passes through a first lens of a cover of the fuel level sensor 114 before reaching the pellet fuel, with the transmitted infrared light passing through the first lens of the cover on a first side of a divider of the cover.

In connection with the second fuel level sensor activation subroutine, the fuel level sensor 114 of FIG. 1 receives infrared light reflected from the pellet fuel located in the pellet fuel storage compartment of the hopper of the pellet grill 100 of FIG. 1. For example, a detection portion of the fuel level sensor 114 (e.g., an infrared receiver of a time-of-flight sensor) can receive infrared light reflected from the pellet fuel (e.g., the wood or charcoal pellets) located within the pellet fuel storage compartment of the hopper of the pellet grill 100 back toward the detection portion. In some examples, the reflected infrared light passes through a second lens of the cover of the fuel level sensor 114 prior to being received at the detection portion of the fuel level sensor 114, with the reflected infrared light passing through the second lens of the cover on a second side of the divider of the cover located opposite the first side of the divider of the cover.

In connection with the second fuel level sensor activation subroutine, the controller 130 of FIG. 1 determines a level or an amount of pellet fuel present in the pellet fuel storage compartment of the hopper of the pellet grill 100 (referenced herein as the “fuel level”) based on the infrared light received at the fuel level sensor 114 of FIG. 1. For example, the controller 130 can determine the fuel level by accessing correlation data that identifies and/or otherwise indicates a fuel level corresponding to the sensed, measured, and/or detected timing (e.g., time of travel) and/or amount (e.g., quantity) of infrared light (e.g., reflected from the pellet fuel) received at the detection portion of the fuel level sensor 114.

In connection with the second fuel level sensor activation subroutine, the controller 130 of FIG. 1 evaluates whether the determined fuel level is below one or more fuel level threshold(s). For example, the controller 130 can compare the determined fuel level to a first fuel level threshold corresponding to the pellet fuel storage compartment of the hopper being occupied with pellet fuel by a first threshold amount (e.g., 50% of the compartment). As another example, the controller 130 can compare the determined fuel level to a second fuel level threshold corresponding to the pellet fuel storage compartment of the hopper being occupied with pellet fuel by a second threshold amount (e.g., 25% of the compartment) that differs from the first threshold amount.

In connection with the second fuel level sensor activation subroutine, the controller 130 of FIG. 1, in response to detecting that the determined fuel level is below at least one of the one or more fuel level threshold(s), instructs, commands, signals, and/or otherwise causes one or more notification(s) associated with the determined fuel level to be presented locally and/or remotely. For example, the controller 130 can instruct, command, signal, and/or otherwise cause the user interface 120 of the pellet grill 100 of FIG. 1 to locally present (e.g., via one or more of the output device(s) 124 of the user interface 120) one or more notification(s) identifying and/or otherwise indicating the determined fuel level and/or the fuel level threshold(s). As another example, the controller 130 can additionally or alternatively instruct, command, signal, and/or otherwise cause the network interface 126 of the pellet grill 100 of FIG. 1 to transmit (e.g., via one or more of the communication device(s) 128 of the network interface 126) one or more notification(s) identifying and/or otherwise indicating the determined fuel level and/or the fuel level threshold(s) to one or more of the remote device(s) 136 of FIG. 1 for remote presentation via one or more of the output device(s) of the remote device(s) 136. In some examples, one or more of the notification(s) identifying and/or otherwise indicating the determined fuel level of the pellet grill 100 can be expressed (e.g., textually, graphically, visually, and/or audibly represented) as a percentage of a maximum capacity (e.g., the fuel level is at 80% of the maximum capacity, the fuel level is 50% of the maximum capacity, etc.). In other examples, one or more of the notification(s) identifying and/or otherwise indicating the determined fuel level of the pellet grill 100 can be expressed (e.g., textually, graphically, visually, and/or audibly represented) in more relative and/or more general terms (e.g., the fuel level is high, the fuel level is low, etc.). In still other examples, one or more of the notification(s) identifying and/or otherwise indicating the determined fuel level of the pellet grill 100 can express (e.g., textually, graphically, visually, and/or audibly represent) that the determined fuel level is below at least one of the one or more fuel level threshold(s).

In some examples, the controller 130 of FIG. 1 implements the second fuel level sensor activation subroutine as a looped control function or subroutine, with such implementation continuing until a deactivation triggering event detected by the control system 102 of the pellet grill 100 dictates otherwise (e.g., detection of the control system 102 of the pellet grill 100 being in or transitioning into an OFF state, detection of the control system 102 of the pellet grill 100 initiating a shutdown sequence, detection of the switch 116 of the pellet grill 100 being in or transitioning into an OFF state, detection that the control system 102 of the pellet grill 100 has received a deactivation request associated with the fuel level sensor 114, etc.).

In some examples, the one or more fuel level threshold(s) associated with the second fuel level sensor activation subroutine as described above is/are predetermined, preset, and/or preconfigured by a manufacturer of the pellet grill 100. In some examples, the one or more fuel level threshold(s) as described above can be changed, modified, edited, and/or otherwise reconfigured by a user of the pellet grill 100 such that the one or more fuel level threshold(s) associated with the second fuel level sensor activation subroutine is/are customized and/or personalized according to the user's preferences. While the above-described example of the second fuel level sensor activation subroutine specifically describes the use of two unique fuel level thresholds, it is to be understood that the second fuel level sensor activation subroutine can instead be implemented using fewer or more unique fuel level thresholds (e.g., a single fuel level threshold, three unique fuel level thresholds, etc.).

The memory 132 of FIG. 1 can be implemented by any type(s) and/or any number(s) of storage device(s) such as an optical storage device, a magnetic storage device, a floppy disk drive, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information). The information and/or data stored in the memory 132 of FIG. 1 can be stored in any file and/or data structure format, organization scheme, and/or arrangement. The memory 132 of FIG. 1 is accessible to one or more of the engine 106 (e.g., including the auger motor 108, the ignitor 110, and the fan 112), the fuel level sensor 114, the switch 116, the state sensor 118, the user interface 120 (e.g., including the input device(s) 122 and the output device(s) 124), the network interface 126 (e.g., including the communication device(s) 128), and/or the controller 130 of the control system 102 of the pellet grill 100 of FIG. 1.

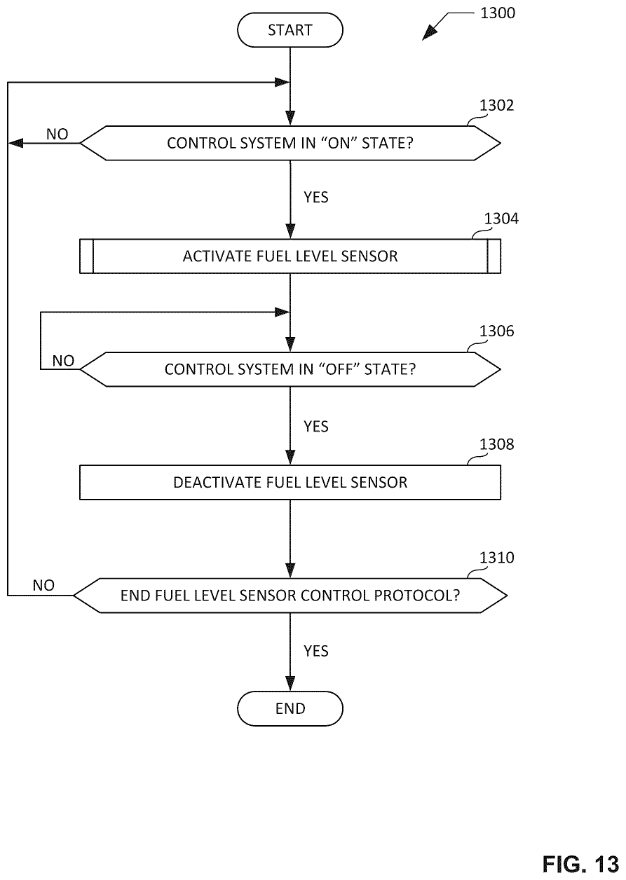

The memory 132 of FIG. 1 stores data sensed, measured, detected, generated, determined, computed, calculated, identified, presented, input, output, transmitted, and/or received by, to, and/or from the engine 106 (e.g., including the auger motor 108, the ignitor 110, and the fan 112), the fuel level sensor 114, the switch 116, the state sensor 118, the user interface 120 (e.g., including the input device(s) 122 and the output device(s) 124), the network interface 126 (e.g., including the communication device(s) 128), and/or the controller 130 of the control system 102 of the pellet grill 100. The memory 132 also stores fuel level correlation data (e.g., correlating determined fuel level to the timing (e.g., time of travel) and/or the amount (e.g., quantity) of infrared light received at the fuel level sensor 114), one or more fuel level threshold(s), and/or settings data (e.g., customized user settings associated with control of the fuel level sensor 114) accessed by the controller 130 of the control system 102 of the pellet grill 100 of FIG. 1. The memory 132 also stores instructions (e.g., computer-readable instructions) and associated data corresponding to one or more fuel level sensor control protocol(s), process(es), program(s), sequence(s), subroutine(s), and/or method(s) described below in connection with FIGS. 13-18.

The remote device(s) 136 of FIG. 1 can be implemented by any type(s) and/or any number(s) of mobile or stationary computing devices. In this regard, examples of such remote device(s) 136 include a smartphone, a tablet, a laptop, a desktop, a cloud server, a wearable computing device, a wireless control hub, etc. The remote device(s) 136 of FIG. 1 facilitate(s) a remote (e.g., wired, or wireless) extension of the above-described user interface 120 of the pellet grill 100. In this regard, each remote device 136 includes one or more input device(s) and/or one or more output device(s) that mimic and/or enable a remotely-located version of the above-described functionality of the corresponding input device(s) 122 and/or the corresponding output device(s) 124 of the user interface 120 of the pellet grill 100. Accordingly, one or more input(s), selection(s), instruction(s), and/or command(s) received at the pellet grill 100 (e.g., via the communication device(s) 128 of the network interface 126 of the pellet grill 100) from the remote device(s) 136 can be entered and/or made via the input device(s) of the remote device(s) 136 much in the same way that such input(s), selection(s), instruction(s), and/or command(s) would be entered and/or made via the input device(s) 122 of the user interface 120 of the pellet grill 100. Similarly, one or more notification(s), prompt(s), request(s), and/or confirmation(s) transmitted from the pellet grill 100 (e.g., via the communication device(s) 128 of the network interface 126 of the pellet grill 100) to the remote device(s) 136 can be presented via the output device(s) of the remote device(s) 136 much in the same way that such notification(s), prompt(s), request(s), and/or confirmation(s) would be presented via the output device(s) 124 of the user interface 120 of the pellet grill 100.

While an example manner of implementing the control system 102 and/or, more generally, the pellet grill 100 is illustrated in FIG. 1, one or more of the elements, processes, and/or devices illustrated in FIG. 1 may be combined, divided, re-arranged, omitted, eliminated, and/or implemented in any other way. Further, the DC power supply 104, the engine 106 (e.g., including the auger motor 108, the ignitor 110, and the fan 112), the fuel level sensor 114, the switch 116, the state sensor 118, the user interface 120 (e.g., including the input device(s) 122 and the output device(s) 124), the network interface 126 (e.g., including the communication device(s) 128), the controller 130, the memory 132, and/or, more generally, the control system 102 of the pellet grill 100 of FIG. 1, may be implemented by hardware alone or by hardware in combination with software and/or firmware. Thus, for example, any of the DC power supply 104, the engine 106 (e.g., including the auger motor 108, the ignitor 110, and the fan 112), the fuel level sensor 114, the switch 116, the state sensor 118, the user interface 120 (e.g., including the input device(s) 122 and the output device(s) 124), the network interface 126 (e.g., including the communication device(s) 128), the controller 130, the memory 132, and/or, more generally, the control system 102 of the pellet grill 100 of FIG. 1 could be implemented at least in part by processor circuitry including any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s). Further still, the example control system 102 of the pellet grill 100 of FIG. 1 may include one or more element(s), component(s), and/or device(s) in addition to, or instead of, those illustrated in FIG. 1, and/or may include more than one of any or all of the illustrated element(s), component(s), and/or device(s).

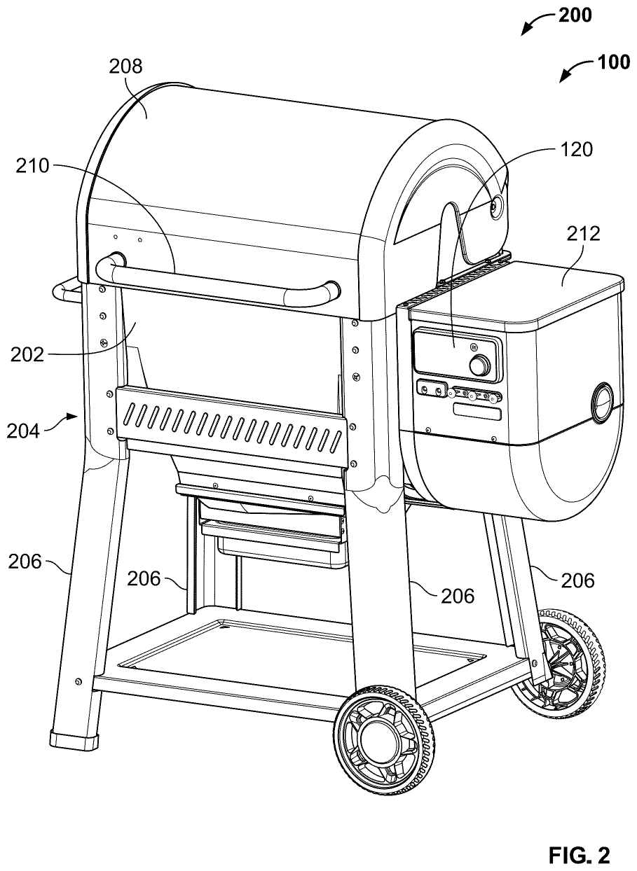

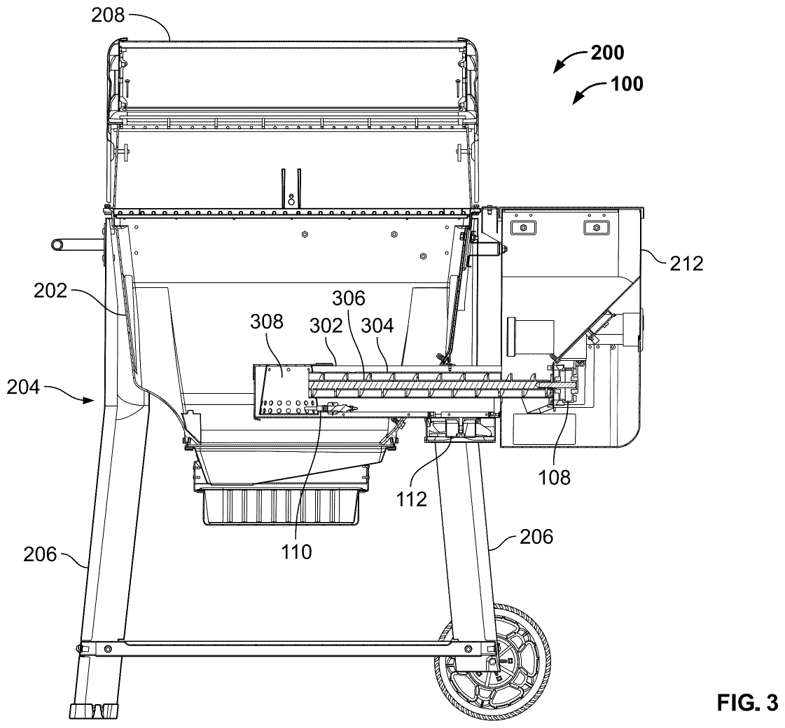

FIG. 2 is perspective view of an example implementation 200 of the pellet grill 100 of FIG. 1. FIG. 3 is a partial cutaway view of the pellet grill 100 of FIG. 2. In the illustrated example of FIGS. 2 and 3, the pellet grill 100 includes an example cookbox 202, with the cookbox 202 being configured to form a cooking chamber suitable for cooking one or more item(s) of food. In some examples, the cookbox 202 of FIGS. 2 and 3 is further configured to house, carry, and/or support one or more cooking grate(s) located and/or positioned within the cookbox 202. In some examples, the cookbox 202 of FIGS. 2 and 3 is further configured to house, carry, and/or support one or more grease deflector(s) and/or one or more heat diffuser(s) located and/or positioned within the cookbox 202 below the cooking grate(s).

The pellet grill 100 of FIGS. 2 and 3 further includes an example frame 204. In the illustrated example of FIGS. 2 and 3, the frame 204 includes one or more example support member(s) 206 (e.g., one or more vertically oriented leg(s)) that are configured to support the cookbox 202 above an underlying ground surface. The support member(s) 206 and/or, more generally, the frame 204 can be configured from any number and any type of structural components arranged in any manner that facilitates supporting the cookbox 202 above an underlying ground surface when the pellet grill 100 is in use. For example, while each of the one or more support member(s) 206 shown in FIGS. 2 and 3 is fixed relative to the cookbox 202, in other examples the frame 204 can include one or more foldable, slidable, and/or telescoping support member(s) 206 that facilitate collapsing and/or otherwise modifying the frame 204 of the pellet grill 100 when the pellet grill 100 is not in use. The pellet grill 100 of FIGS. 2 and 3 can further include any number of tables and/or shelves coupled to the frame 204 and/or the cookbox 202 of the pellet grill 100.

The pellet grill 100 of FIGS. 2 and 3 further includes an example lid 208 configured to cover and/or enclose the cookbox 202 of the pellet grill 100 when the lid 208 is in a closed position. The lid 208 is movable relative to the cookbox 202 between a closed position and an open position in which a cooking surface (e.g., a cooking grate) located on or within the cookbox 202 is exposed. In the illustrated example of FIGS. 2 and 3, the lid 208 is pivotally coupled to the cookbox 202 via one or more hinge(s) and/or pivot(s) that mechanically couple the lid 208 to the cookbox 202. Movement of the lid 208 of the pellet grill 100 between the closed position and the open position can be facilitated via user interaction with an example handle 210 that is coupled to the lid 208.

The pellet grill 100 of FIGS. 2 and 3 further includes an example hopper 212, an example engine housing 302, an example auger tube 304, an example auger 306, the auger motor 108, an example burn pot 308, the ignitor 110, and the fan 112. The hopper 212 is coupled to the cookbox 202 and/or to the frame 204, with the hopper 212 being configured to hold and/or contain a supply of combustible wood or charcoal pellets (e.g., pellet fuel). The auger 306 is located within the auger tube 304. The auger tube 304 and the auger 306 respectively extend from the hopper 212 of the pellet grill 100, through a side opening formed in a sidewall of the cookbox 202, and into a cooking chamber of the cookbox 202 defined by an interior surface of the cookbox 202. Portions of the auger tube 304 and the auger 306 extending into the cooking chamber of the cookbox 202 are located within the engine housing 302. The burn pot 308 and the ignitor 110 are also located within the engine housing 302. The fan 112 is coupled to the engine housing 302. In the illustrated example of FIGS. 2 and 3, the auger tube 304 and the auger 306 respectively extend to and/or or into the burn pot 308 such that that auger tube 304 and the auger 306 collectively transport wood or charcoal pellets from the hopper 212 into the burn pot 308. A first end of the ignitor 110 also extends into the burn pot 308 such that a heat-generating portion (e.g., an ignition tip) of the ignitor 110 contacts at least some of the wood or charcoal pellets received in the burn pot 308.

During operation of the pellet grill 100, combustible wood or charcoal pellets pass from the hopper 212 into the auger tube 304 of the pellet grill 100. Combustible wood or charcoal pellets received in the auger tube 304 from the hopper 212 are thereafter transported through the auger tube 304 toward and/or into the burn pot 308 of the pellet grill 100 via rotation of the auger 306 of the pellet grill 100 (e.g., as driven by the auger motor 108 of the pellet grill 100). Combustion of the wood or charcoal pellets received in the burn pot 308 can be initiated via activation of the ignitor 110 of the pellet grill 100. Once combustion of the wood or charcoal pellets received in the burn pot 304 has commenced via the ignition process, the rate of such combustion can be managed via a controlled airflow generated by the fan 112 of the pellet grill 100, with said airflow being delivered from the fan 112 into the engine housing 302 of the pellet grill 100, and through the engine housing 302 to the burn pot 308.

The pellet grill 100 of FIGS. 2 and 3 further includes the DC power supply 104, the fuel level sensor 114, the switch 116, the state sensor 118, the user interface 120, the network interface 126, the controller 130, and/or the memory 132 described above in connection with FIG. 1. In the illustrated example of FIGS. 2 and 3, fuel level sensor 114 and/or the user interface 120 is/are coupled and/or mounted to the hopper 212 of the pellet grill 100. The DC power supply 104, the switch 116, the state sensor 118, the network interface 126, the controller 130, and/or the memory 132 can also be coupled and/or mounted to the hopper 212 of the pellet grill 100, or can alternatively be coupled and/or mounted to another structural component of the pellet grill 100 such as the frame 204 or the cookbox 202 of the pellet grill 100, and/or to a table or shelf of the pellet grill 100.

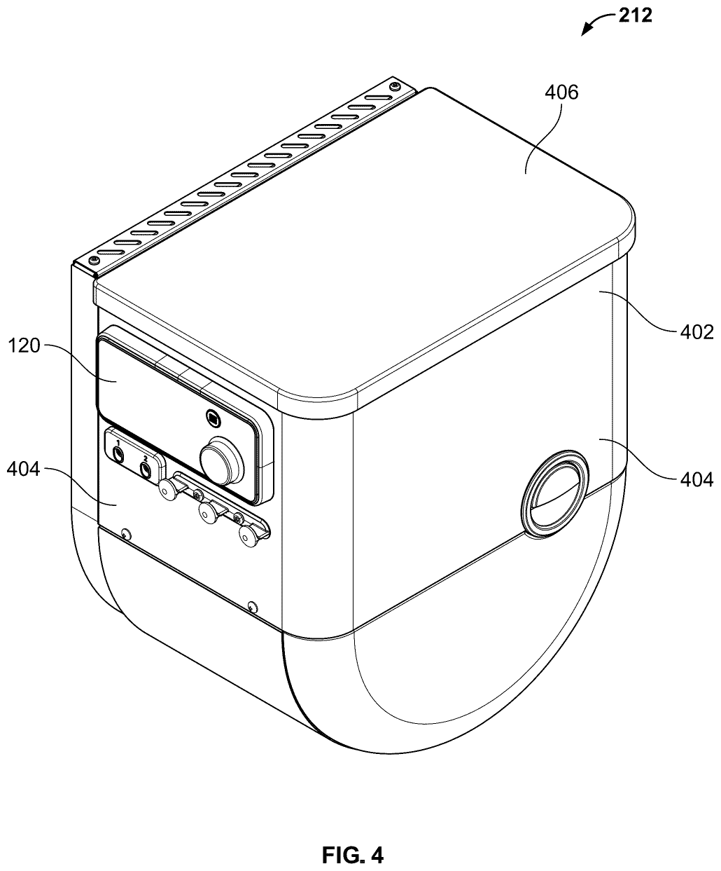

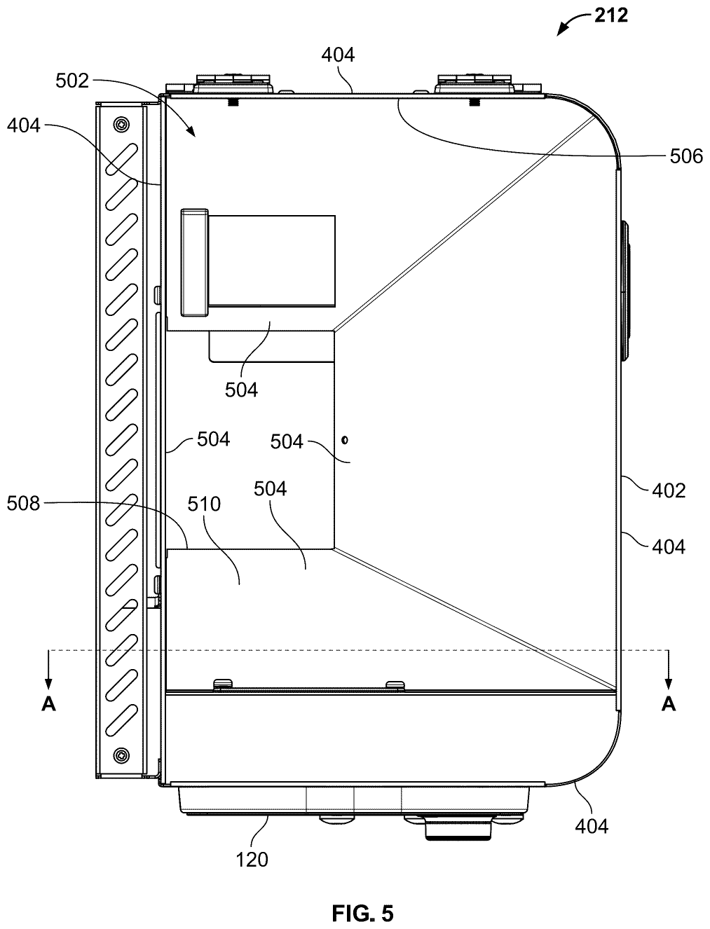

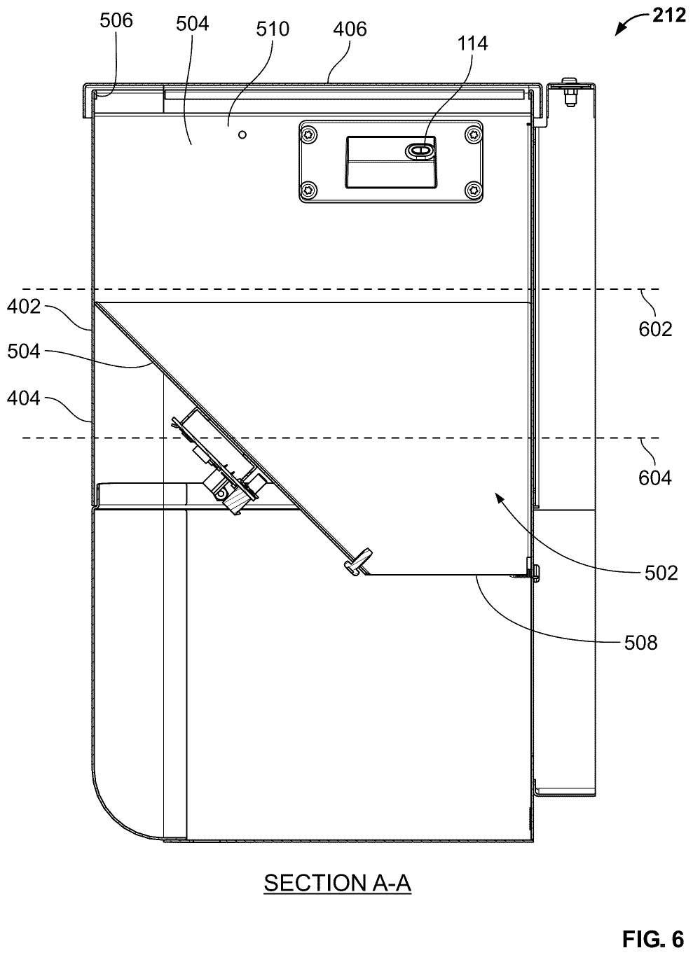

FIG. 4 is a perspective view of the hopper 212 of the pellet grill 100 of FIGS. 2 and 3, with the hopper 212 shown in isolation. FIG. 5 is a top view of the hopper 212 of FIG. 4, with the lid of the hopper 212 omitted. FIG. 6 is a cross-sectional view of the hopper 212 of FIGS. 4 and 5 taken along section A-A of FIG. 6. In the illustrated example of FIGS. 4-6, the hopper 212 includes an example housing 402 and example pellet fuel storage compartment 502. The housing 402 of the hopper 212 includes and/or is formed by one or more example exterior wall(s) 404. The pellet fuel storage compartment 502 of the hopper 212 is located within the housing 402 of the hopper 212. The pellet fuel storage compartment 502 is configured to hold and/or contain a supply of combustible wood or charcoal pellets (e.g., pellet fuel). The pellet fuel storage compartment 502 of the hopper 212 includes and/or is formed by one or more example interior wall(s) 504. In the illustrated example of FIGS. 4-6, one or more of the interior wall(s) 504 of the hopper 212 is/are oriented in a non-vertical plane. In some examples, one or more gap(s) are present between the exterior wall(s) 404 that define(s) the housing 402 of the hopper 212 and the interior wall(s) 504 that define(s) the pellet fuel storage compartment 502 of the hopper 212. In some examples, such gaps form cavities and/or compartments that are suitably configured for receiving one or more portion(s) of the DC power supply 104, the auger motor 108, the fuel level sensor 114, the switch 116, the state sensor 118, the user interface 120, the network interface 126, the controller 130, and/or the memory 132 of the pellet grill 100.

In the illustrated example of FIGS. 4-6, the pellet fuel storage compartment 502 of the hopper 212 of includes an example intake opening 506 and an example feed opening 508. The intake opening 506 of the pellet fuel storage compartment 502 is located proximate the upper end of the interior wall(s) 504 of the hopper 212. The intake opening 506 of the pellet fuel storage compartment 502 is configured to intake and/or receive combustible wood or charcoal pellets into the pellet fuel storage compartment 502 when a lid of the hopper 212 is in an open position, as further described below. The feed opening 508 of the pellet fuel storage compartment 502 is located proximate the lower end of the interior wall(s) 504 of the hopper 212, opposite the intake opening 506 of the pellet fuel storage compartment 502. The feed opening 508 of the pellet fuel storage compartment 502 is configured to feed and/or expel combustible wood or charcoal pellets from the pellet fuel storage compartment 502 into the auger tube 304 of the pellet grill 100. Combustible wood or charcoal pellets deposited into the pellet fuel storage compartment 502 of the hopper 212 via the intake opening 506 are stored within the pellet fuel storage compartment 502 for a temporary duration (e.g., minutes, hours, days, weeks, etc.) until such combustible wood or charcoal pellets are drawn from the pellet fuel storage compartment 502, through the feed opening 508, and into the auger tube 304 of the pellet grill 100 by a combination of gravity and operation of the auger 306 of the pellet grill 100.

In the illustrated example of FIGS. 4-6, the hopper 212 further includes an example lid 406 configured to cover and/or enclose the pellet fuel storage compartment 502 of the hopper 212 when the lid 406 is in a closed position. The lid 406 of the hopper 212 is movable relative to the housing 402 of the hopper 212 between a closed position and an open position in which the intake opening 506 of the pellet fuel storage compartment 502 of the hopper 212 is exposed. Combustible wood or charcoal pellets can be deposited into the pellet fuel storage compartment 502 of the hopper 212 via the intake opening 506 of the pellet fuel storage compartment 502 when the lid 406 of the hopper 212 is in the open position. In the illustrated example of FIGS. 4-6, the lid 406 of the hopper 212 is pivotally coupled to the housing 402 of the hopper 212 via one or more hinge(s) and/or pivot(s) that mechanically couple the lid 406 to the housing 402.

In the illustrated example of FIGS. 4-6, the fuel level sensor 114 of the pellet grill 100 is located on and/or in the hopper 212 of the pellet grill 100 at a position that enables the fuel level sensor 114 to sense, measure, and/or detect the level or amount of pellet fuel present in the pellet fuel storage compartment 502 of the hopper 212. In the illustrated example of FIGS. 4-6, the fuel level sensor 114 of the pellet grill 100 is mounted on and/or otherwise located along one or more of the interior wall(s) 504 of the hopper 212. For example, as shown in FIG. 6, the fuel level sensor 114 is mounted on and/or otherwise located along an example front interior wall 510 of the hopper 212. In other examples, the fuel level sensor 114 can instead be mounted on and/or located along a different one of the interior wall(s) 504 of the hopper 212, such as a rear interior wall or a side interior wall of the hopper 212. In still other examples, the fuel level sensor 114 can instead be mounted on and/or located along an underside of the lid 406 of the hopper 212.

In the illustrated example of FIGS. 4-6, one or more fuel level threshold(s) are associated with the fuel level sensor 114 and/or the pellet fuel storage compartment 502 of the hopper 212. As shown in FIG. 6, an example first fuel level threshold 602 corresponds to the pellet fuel storage compartment 502 of the hopper 212 being occupied with pellet fuel by a first threshold amount (e.g., 50% of the compartment). As further shown in FIG. 6, an example second fuel level threshold 604 corresponds to the pellet fuel storage compartment 502 of the hopper 212 being occupied with pellet fuel by a second threshold amount (e.g., 25% of the compartment) that is less than the first threshold amount. While the illustrated example of FIGS. 4-6 shows the use of two unique fuel level thresholds, it is to be understood that a different number of unique fuel level thresholds (e.g., a single fuel level threshold, three unique fuel level thresholds, etc.) can instead be implemented.

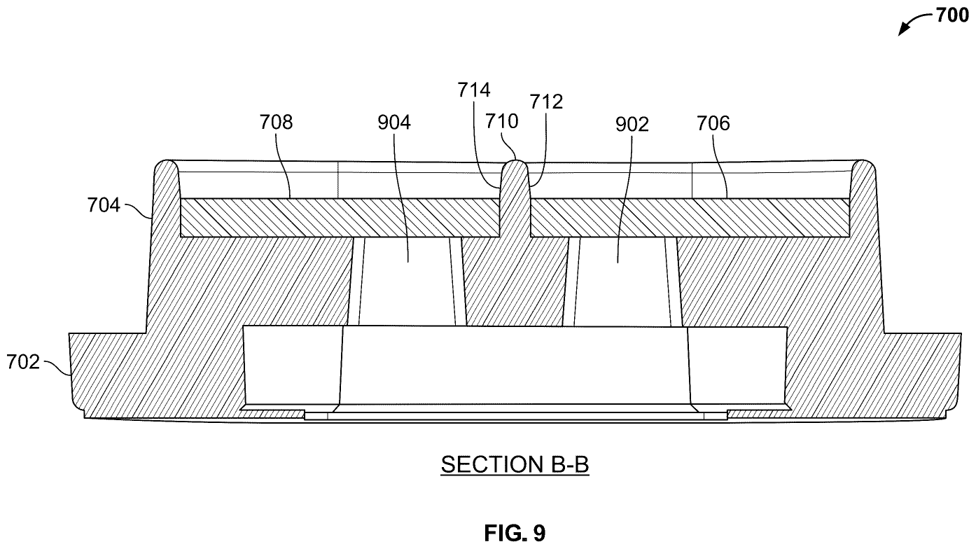

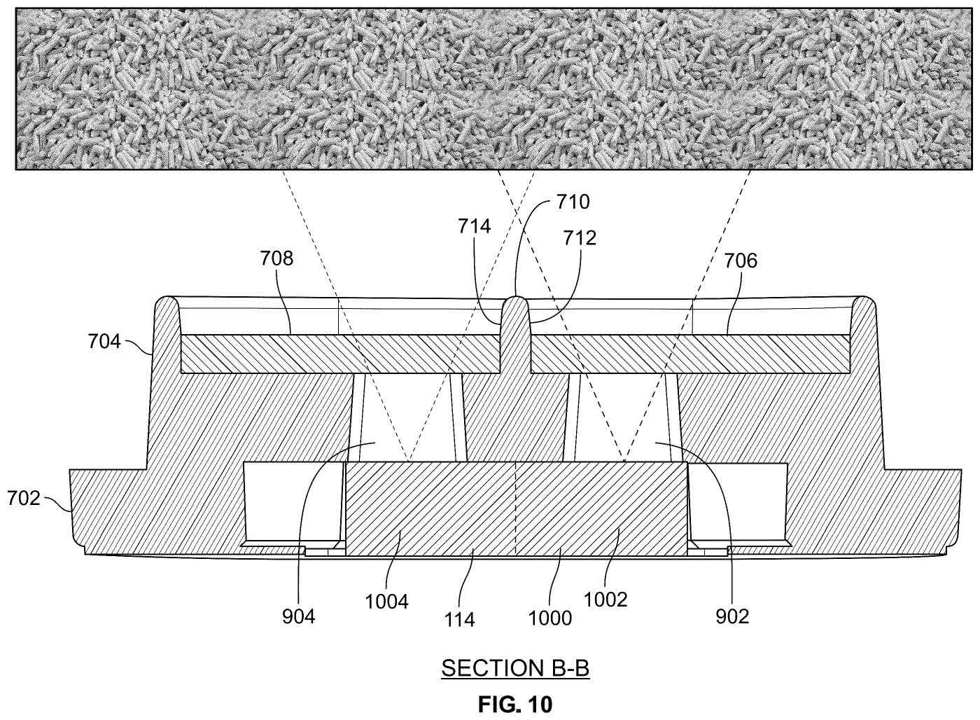

FIG. 7 is a perspective view of an example cover 700 for the fuel level sensor 114 of FIG. 1, as implemented in the hopper 212 of FIGS. 2-6. FIG. 8 is a top view of the cover 700 of FIG. 7. FIG. 9 is a cross-sectional view of the cover 700 of FIGS. 7 and 8 taken along section B-B of FIG. 8. FIG. 10 is a cross-sectional view of the cover 700 of FIGS. 7-9 taken along section B-B of FIG. 8, showing the cover 700 positioned over an example implementation 1000 of the fuel level sensor 114 of FIG. 1. In the illustrated example of FIGS. 7-10, the fuel level sensor 114 includes an example transmission portion 1002 and an example detection portion 1004. The transmission portion 1002 of the fuel level sensor 114 is configured to transmit infrared light toward pellet fuel located within the pellet fuel storage compartment 502 of the hopper 212. In some examples, the transmission portion 1002 of the fuel level sensor 114 includes and/or is implemented by an infrared transmitter (e.g., an infrared laser) of a time-of-flight sensor. The detection portion 1004 of the fuel level sensor 114 is configured to receive infrared light reflected from the pellet fuel toward the detection portion 1004. In some examples, the detection portion 1004 of the fuel level sensor 114 includes and/or is implemented by an infrared receiver of a time-of-flight sensor.

In order to accurately sense, measure, and/or detect the level and/or amount of pellet fuel remaining in the pellet fuel storage compartment 502 of the hopper 212 of the pellet grill 100, the transmission portion 1002 and the detection portion 1004 of the fuel level sensor 114 need to be protected and/or shielded from particulate (e.g., pellet fuel dust) and/or wear (e.g., scratches, scuffs, etc.). In some known pellet grills, such protection is achieved via a cover that includes a single lens. As particulate (e.g., pellet fuel dust) and/or wear (e.g., scratches, scuffs, etc.) accumulate(s) on the single lens of such a cover, the infrared light transmitted by the transmission portion 1002 of the fuel level sensor 114 reflects off of the particulate and/or wear marks and is prematurely redirected back toward the detection portion 1004 of the fuel level sensor 114. Such crosstalk produces erroneous, skewed, inaccurate, and/or unreliable fuel level detections and/or determinations by the fuel level sensor 114. For example, such crosstalk may cause the fuel level sensor 114 to determine that the pellet fuel storage compartment 502 of the hopper 212 is nearly full, even when the pellet fuel storage compartment 502 of the hopper 212 is in reality nearly empty.

The cover 700 of FIGS. 7-10 overcomes the above-described disadvantages of implementing a cover for the fuel level sensor 114 that includes only a single lens. In the illustrated example of FIGS. 7-10, the cover 700 includes an example base 702, an example sidewall 704, an example first lens 706, an example second lens 708, and an example divider 710. The base 702 of the cover 700 is configured to be coupled and/or mounted to a printed circuit board (PCB), as further described below. The sidewall 704 of the cover 700 extends from the base 702 of the cover 700, with the sidewall 704 supporting and/or carrying the first lens 706, the second lens 708, and the divider 710 of the cover 700. In the illustrated example of FIGS. 7-10, the base 702 and/or the sidewall 704 of the cover individually or collectively circumscribe the fuel level sensor 114. The base 702 and the sidewall 704 of the cover 700 of FIGS. 7-10 are fabricated from material that blocks and/or otherwise restricts the passage and/or transmission of infrared light therethrough (e.g., an infrared opaque material).

The first lens 706 and the second lens 708 of the cover 700 of FIGS. 7-10 are respectively located between the fuel level sensor 114 and pellet fuel located within the pellet fuel storage compartment 502 of the hopper 212. The first lens 706 and the second lens 708 of the cover 700 advantageously shield the fuel level sensor 114 from particulate (e.g., pellet fuel dust) and/or wear (e.g., scratches, scuffs, etc.), thereby eliminating the need to keep the fuel level sensor 114 itself clean. The first lens 706 and the second lens 708 of the cover 700 of FIGS. 7-10 are fabricated from material that enables the passage and/or transmission of infrared light therethrough (e.g., an infrared transparent material). Infrared light transmitted from the transmission portion 1002 of the fuel level sensor 114 can accordingly pass through the first lens 706 of the cover 700 as the infrared light moves away from the transmission portion 1002 and toward the pellet fuel. Similarly, infrared light reflected from the pellet fuel toward the detection portion 1004 of the fuel level sensor 114 can pass through the second lens 708 of the cover 700 as the reflected infrared light moves away from the pellet fuel and toward the detection portion 1004.

The divider 710 of the cover 700 of FIGS. 7-10 provides optical separation between the transmission portion 1002 and the detection portion 1004 of the fuel level sensor 114, and also provides optical separation between the first lens 706 and the second lens 708 of the cover 700. In the illustrated example of FIGS. 7-10, the divider 710 of the cover 700 includes an example first side 712 and an example second side 714 located opposite the first side 712. The transmission portion 1002 of the fuel level sensor 114 is located on the first side 712 of the divider 710, and the detection portion 1004 of the fuel level sensor 114 is located on the second side 714 of the divider 710. The divider 710 of FIGS. 7-10 separates and/or divides an interior portion of the cover 700 into an example first compartment 902 formed in part by the first side 712 of the divider 710 and an example second compartment 904 formed in part by the second side 714 of the divider 710. In the illustrated example of FIGS. 7-10, the transmission portion 1002 of the fuel level sensor 114 is aligned with the first compartment 902 of the cover 700, and the detection portion 1004 of the fuel level sensor 114 is aligned with the second compartment 904 of the cover 700. The divider 710 of the cover 700 of FIGS. 7-10 is fabricated from material that blocks and/or otherwise restricts the passage and/or transmission of infrared light therethrough (e.g., an infrared opaque material).

In the illustrated example of FIGS. 7-10, infrared light transmitted from the transmission portion 1002 of the fuel level sensor 114 toward the pellet fuel passes from the first compartment 902 of the cover 700 through the first lens 706 of the cover 700 on the first side 712 of the divider 710 of the cover 700. By contrast, infrared light reflected from the pellet fuel toward the detection portion 1004 of the fuel level sensor 114 passes through the second lens 708 of the cover 700 on the second side 714 of the divider 710 of the cover 700 into the second compartment 904 of the cover 700. The structural configuration and the material properties of the divider 710 (e.g., that the divider completely separates the first lens 706 and the second lens 708, and that the divider is formed from an infrared opaque material) advantageously reduce (e.g., prevent) crosstalk associated with infrared light transmitted from the transmission portion 1002 of the fuel level sensor 114. This remains true even in instances when there is a significant accumulation of particulate (e.g., pellet fuel dust) and/or wear (e.g., scratches, scuffs, etc.) present on the first lens 706 and/or the second lens 708 of the cover 700. The accuracy of the fuel level sensor 114 is accordingly enhanced relative to fuel level detection systems that either do not include any form of a cover for the fuel level sensor 114, or that include a cover having only a single lens and lacking a divider of the type described above. The presence of the divider 710 also advantageously reduces (e.g., minimizes or eliminates) the need for manual cleaning of the cover 700 by a user of the pellet grill 100, and/or the need for recalibration of the fuel level sensor 114 arising from an accumulation of particulate (e.g., pellet fuel dust) and/or wear (e.g., scratches, scuffs, etc.) on the cover 700. The divider 710 accordingly extends the usable life of the fuel level sensor 114 as well as the cover 700 itself.

The cover 700 of FIGS. 7-10 also facilitates accurate fuel level detection measurement for dark materials such as charcoal pellets. Known fuel level sensors (e.g., either with or without a cover) are unable to accurately detect the level and/or amount of charcoal pellets remaining in the pellet fuel storage compartment of a hopper. This shortcoming is attributed to a combination of (1) the dark color of the charcoal pellets, which results in absorption of nearly all of the infrared light that is transmitted toward the pellet fuel by the transmission portion of the fuel level sensor, and (2) the presence of crosstalk, which often rises to a level of significance which overshadows the timing and/or the amount of any infrared light that is reflected from the pellet fuel and received at the detection portion of the fuel level sensor. The presence of the divider 710 of the cover 700 of FIGS. 7-10 eliminates the above-described shortcoming, particularly in view of the elimination of crosstalk, as described above. Accurate detection of the level and/or amount of charcoal pellets located in the pellet fuel storage compartment 502 of the hopper 212 of the pellet grill 100 is accordingly made possible by the cover 700 of FIGS. 7-10.

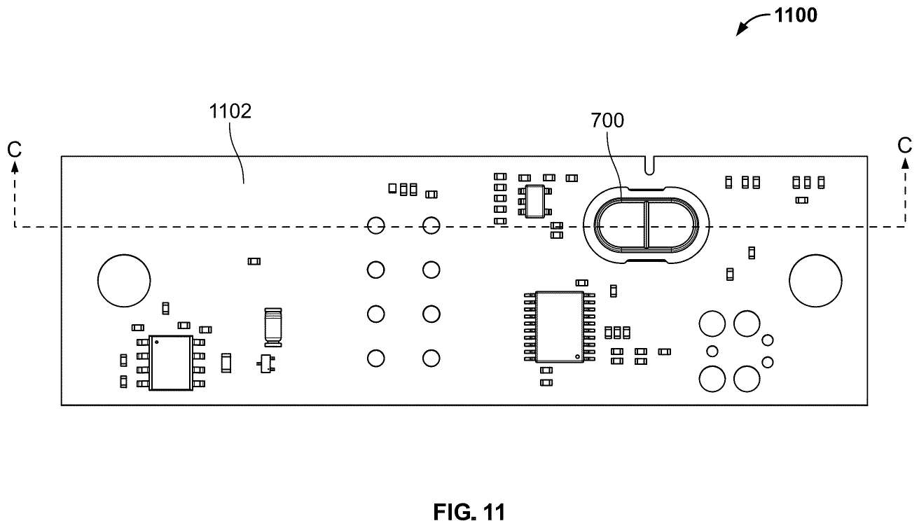

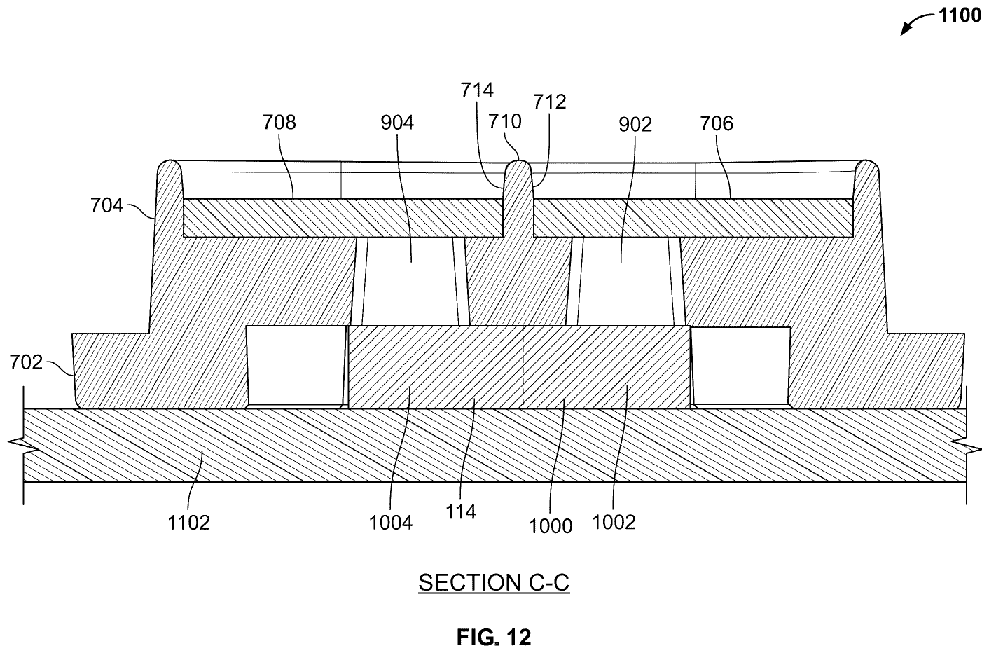

FIG. 11 is an example printed circuit board assembly (PCBA) 1100 implemented in the hopper 212 of FIGS. 2-6. The PCBA 1100 of FIG. 11 includes an example printed circuit board (PCB) 1102, the fuel level sensor 114, and the cover 700. FIG. 12 is a cross-sectional view of the PCBA 1100 of FIG. 11 taken along section C-C of FIG. 11, showing the fuel level sensor 114 and the cover 700 positioned on the PCB 1102, with the cover 700 shown covering, protecting, and/or shielding the fuel level sensor 114. In the illustrated example of FIGS. 11 and 12, the fuel level sensor 114 is coupled and/or mounted to the PCB 1102. The cover 700 is also coupled and/or mounted to the PCB 1102. The fuel level sensor 114 is positioned between the PCB 1102 and one or more of the first lens 706 and the second lens 708 of the cover 700. In some examples, the PCBA 1100 is configured to be located along an interior wall that defines the pellet fuel storage compartment 502 of the hopper 212, as described above.

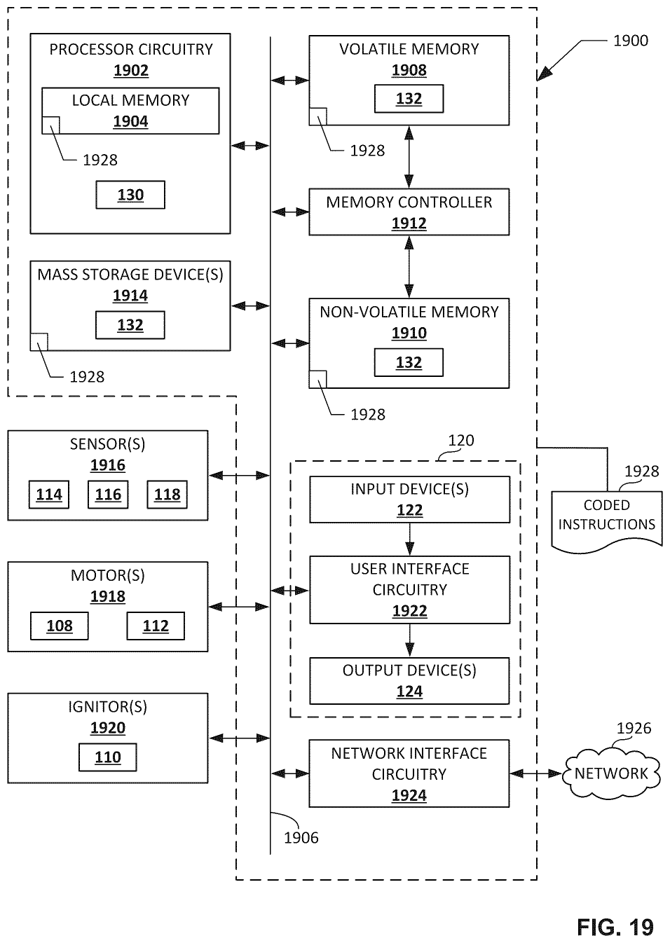

Flowcharts representing example machine-readable instructions, which may be executed to configure processor circuitry to implement the pellet grill 100 of FIG. 1, are shown in FIGS. 13-18. The machine-readable instructions may be one or more executable program(s) or portion(s) thereof for execution by processor circuitry, such as the processor circuitry 1902 shown in the example processor platform 1900 discussed below in connection with FIG. 19. The program(s) may be embodied in software stored on one or more non-transitory computer readable storage media such as an optical storage device, a magnetic storage device, a floppy disk drive, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk associated with processor circuitry located in one or more hardware device(s).

Alternatively, the entire program(s) and/or the portion(s) thereof could be executed by one or more hardware device(s) other than the processor circuitry and/or embodied in firmware or dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer-readable storage media may include one or more medium(s) located in one or more hardware device(s). Further, although example programs are described with reference to the flowcharts illustrated in FIGS. 13-18, many other methods of implementing the example pellet grill 100 of FIG. 1 may alternatively be used. For example, the order of execution of the blocks may be changed, and/or some of the blocks described may be changed, eliminated, or combined. Additionally, or alternatively, any or all of the blocks may be implemented by one or more hardware circuit(s) (e.g., processor circuitry) and/or hardware device(s) structured to perform the corresponding operation(s) without executing software or firmware. The hardware circuit(s) and/or hardware device(s) can be located on a single machine, or can be located across multiple machines in different network locations.

The machine-readable instructions described herein may be stored in one or more of a compressed format, an encrypted format, a fragmented format, a compiled format, an executable format, a packaged format, etc. Machine-readable instructions as described herein may be stored as data or a data structure (e.g., as portions of instructions, code, representations of code, etc.) that may be utilized to create, manufacture, and/or produce machine-executable instructions. For example, the machine-readable instructions may be fragmented and stored on one or more storage device(s) and/or computing device(s) (e.g., one or more server(s)) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or any other machine. For example, the machine-readable instructions may be stored in multiple parts, which are individually compressed, encrypted, and/or stored on separate computing devices, wherein the parts when decrypted, decompressed, and/or combined form a set of machine-executable instructions that implement one or more operation(s) that may together form a program such as that described herein.

In another example, the machine-readable instructions may be stored in a state in which they may be read by processor circuitry, but require addition of a library (e.g., a dynamic link library (DLL)), a software development kit (SDK), an application programming interface (API), etc., in order to execute the machine-readable instructions on a particular computing device or any other device. In another example, the machine-readable instructions may need to be configured (e.g., settings stored, data input, network addresses recorded, etc.) before the machine-readable instructions and/or the corresponding program(s) can be executed in whole or in part. Thus, machine-readable media, as used herein, may include machine-readable instructions and/or program(s) regardless of the particular format or state of the machine-readable instructions and/or program(s) when stored or otherwise at rest or in transit. The machine-readable instructions described herein can be represented by any past, present, or future instruction language, scripting language, programming language, etc. For example, the machine-readable instructions may be represented using any of the following languages: C, C++, C#, Java, JavaScript, Python, Perl, HyperText Markup Language (HTML), Structured Query Language (SQL), Non-relational SQL (NoSQL), Swift, etc.

As mentioned above, the example operations of FIGS. 13-18 may be implemented using executable instructions (e.g., computer and/or machine-readable instructions) stored on one or more non-transitory computer and/or machine-readable media such as an optical storage device, a magnetic storage device, a hard disk drive (HDD), a solid state storage device, a flash memory, a read-only memory (ROM), a random-access memory (RAM), a volatile memory, a non-volatile memory, a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information).

FIG. 13 is a flowchart representative of example machine-readable instructions and/or example operations 1300 that may be executed by processor circuitry (e.g., processor circuitry of the controller 138 of FIG. 1) to implement a first fuel level sensor control process via the pellet grill 100 of FIG. 1. The machine-readable instructions and/or operations 1300 of FIG. 13 begin at Block 1302 when the processor circuitry of the controller 130 of FIG. 1 determines whether the control system 102 of the pellet grill 100 of FIG. 1 is in an ON state (e.g., a powered state). For example, the processor circuitry of the controller 130 can determine, based on data sensed, measured, and/or detected by the state sensor 118 of FIG. 1, that the control system 102 of the pellet grill 100 is in an ON state. If the processor circuitry of the controller 130 determines at Block 1302 that the control system 102 of the pellet grill 100 is in an ON state, control of the machine-readable instructions and/or operations 1300 of FIG. 13 proceeds to Block 1304. If the processor circuitry of the controller 130 instead determines at Block 1302 that the control system 102 of the pellet grill 100 is not in an ON state, control of the machine-readable instructions and/or operations 1300 of FIG. 13 remains at Block 1302.

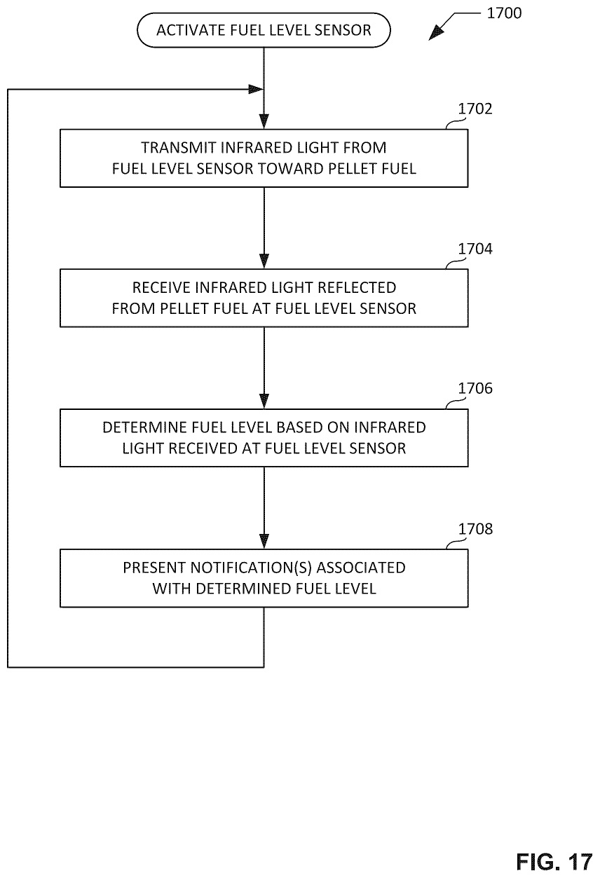

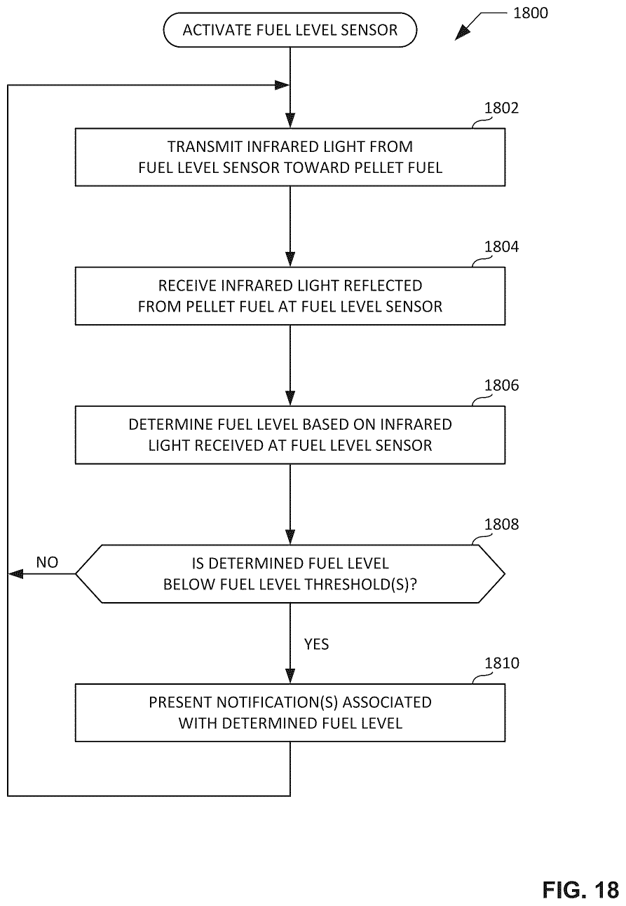

At Block 1304, the processor circuitry of the controller 130 of FIG. 1 commands, instructs, signals, and/or otherwise causes the fuel level sensor 114 of FIG. 1 to activate (e.g., to begin operating). Various fuel level sensor activation subroutines that can be implemented by the processor circuitry of the controller 130 of FIG. 1 in connection with performing and/or executing Block 1304 of the first fuel level sensor control process 1300 of FIG. 13 are described below in connection with FIGS. 17-18. Following Block 1304, control of the machine-readable instructions and/or operations 1300 of FIG. 13 proceeds to Block 1306.

At Block 1306, the processor circuitry of the controller 130 of FIG. 1 determines whether the control system 102 of the pellet grill 100 of FIG. 1 is in an OFF state (e.g., unpowered, or in the process of losing power). For example, the processor circuitry of the controller 130 can determine, based on data sensed, measured, and/or detected by the state sensor 118 of FIG. 1, that the control system 102 of the pellet grill 100 is in an OFF state. If the processor circuitry of the controller 130 determines at Block 1306 that the control system 102 of the pellet grill 100 is in an OFF state, control of the machine-readable instructions and/or operations 1300 of FIG. 13 proceeds to Block 1308. If the processor circuitry of the controller 130 instead determines at Block 1306 that the control system 102 of the pellet grill 100 is not in an OFF state, control of the machine-readable instructions and/or operations 1300 of FIG. 13 remains at Block 1306.

At Block 1308, the processor circuitry of the controller 130 of FIG. 1 commands, instructs, signals, and/or otherwise causes the fuel level sensor 114 of FIG. 1 to deactivate (e.g., to cease operating). Following Block 1308, control of the machine-readable instructions and/or operations 1300 of FIG. 13 proceeds to Block 1310.

At Block 1310, the processor circuitry of the controller 130 of FIG. 1 determines whether to end the first fuel level sensor control process and/or protocol set forth in FIG. 13. For example, the processor circuitry of the controller 130 can determine whether the user interface 120 and/or the network interface 126 of the control system 102 of FIG. 1 has/have received any commands, instructions, signals, inputs, and/or other data indicative of a request to terminate the first fuel level sensor control process and/or protocol of FIG. 13. If the processor circuitry of the controller 130 determines at Block 1310 that the first fuel level sensor control process and/or protocol of FIG. 13 is to continue (e.g., that no termination request has been received), control of the machine-readable instructions and/or operations 1300 of FIG. 13 returns to Block 1302. If the processor circuitry of the controller 130 instead determines at Block 1310 that the first fuel level sensor control process and/or protocol of FIG. 13 is to cease or terminate (e.g., that a termination request has been received), the machine-readable instructions and/or operations 1300 of FIG. 13 end.

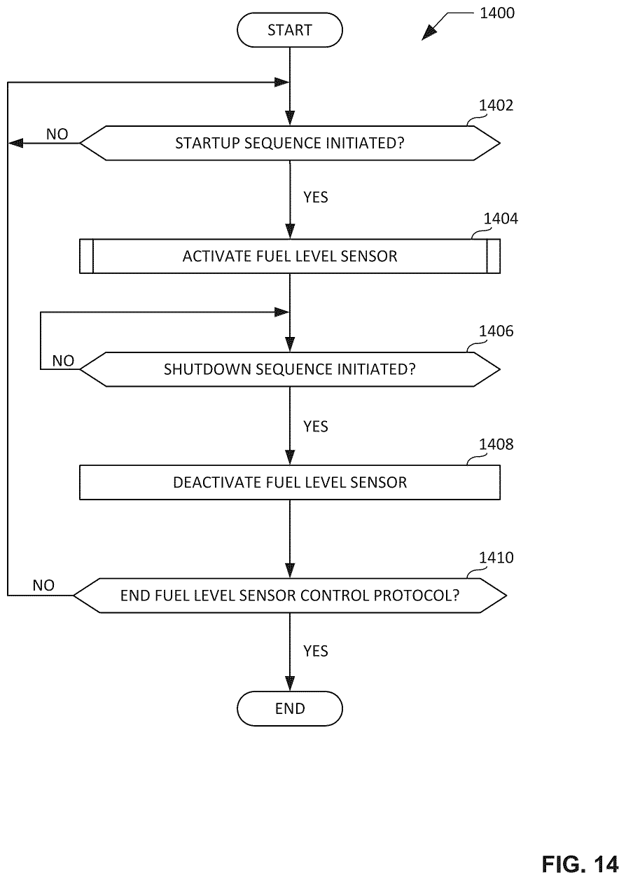

FIG. 14 is a flowchart representative of example machine-readable instructions and/or example operations 1400 that may be executed by processor circuitry (e.g., processor circuitry of the controller 130 of FIG. 1) to implement a second fuel level sensor control process via the pellet grill 100 of FIG. 1. The machine-readable instructions and/or operations 1400 of FIG. 14 begin at Block 1402 when the processor circuitry of the controller 130 of FIG. 1 determines whether a startup sequence of the pellet grill 100 of FIG. 1 (e.g., a sequence that powers on the pellet grill 100 and/or that causes an ignitor of the pellet grill 100 to be in an ON state) has been initiated. For example, the processor circuitry of the controller 130 can determine, based on data sensed, measured, and/or detected by the state sensor 118 of FIG. 1, that a startup sequence of the pellet grill 100 has been initiated. If the processor circuitry of the controller 130 determines at Block 1402 that a startup sequence of the pellet grill 100 has been initiated, control of the machine-readable instructions and/or operations 1400 of FIG. 14 proceeds to Block 1404. If the processor circuitry of the controller 130 instead determines at Block 1402 that a startup sequence of the pellet grill 100 has not been initiated, control of the machine-readable instructions and/or operations 1400 of FIG. 14 remains at Block 1402.

At Block 1404, the processor circuitry of the controller 130 of FIG. 1 commands, instructs, signals, and/or otherwise causes the fuel level sensor 114 of FIG. 1 to activate (e.g., to begin operating). Various fuel level sensor activation subroutines that can be implemented by the processor circuitry of the controller 130 of FIG. 1 in connection with performing and/or executing Block 1404 of the second fuel level sensor control process 1400 of FIG. 14 are described below in connection with FIGS. 17-18. Following Block 1404, control of the machine-readable instructions and/or operations 1400 of FIG. 14 proceeds to Block 1406.

At Block 1406, the processor circuitry of the controller 130 of FIG. 1 determines whether a shutdown sequence of the pellet grill 100 of FIG. 1 (e.g., a sequence that causes an auger motor, an ignitor, a fan, and/or, more generally, the pellet grill 100 to be shut down and/or powered off) has been initiated. For example, the processor circuitry of the controller 130 can determine, based on data sensed, measured, and/or detected by the state sensor 118 of FIG. 1, that a shutdown sequence of the pellet grill 100 has been initiated. If the processor circuitry of the controller 130 determines at Block 1406 that a shutdown sequence of the pellet grill 100 has been initiated, control of the machine-readable instructions and/or operations 1400 of FIG. 14 proceeds to Block 1408. If the processor circuitry of the controller 130 instead determines at Block 1406 that a shutdown sequence of the pellet grill 100 has not been initiated, control of the machine-readable instructions and/or operations 1400 of FIG. 14 remains at Block 1406.

At Block 1408, the processor circuitry of the controller 130 of FIG. 1 commands, instructs, signals, and/or otherwise causes the fuel level sensor 114 of FIG. 1 to deactivate (e.g., to cease operating). Following Block 1408, control of the machine-readable instructions and/or operations 1400 of FIG. 14 proceeds to Block 1410.

At Block 1410, the processor circuitry of the controller 130 of FIG. 1 determines whether to end the second fuel level sensor control process and/or protocol set forth in FIG. 14. For example, the processor circuitry of the controller 130 can determine whether the user interface 120 and/or the network interface 126 of the control system 102 of FIG. 1 has/have received any commands, instructions, signals, inputs, and/or other data indicative of a request to terminate the second fuel level sensor control process and/or protocol of FIG. 14. If the processor circuitry of the controller 130 determines at Block 1410 that the second fuel level sensor control process and/or protocol of FIG. 14 is to continue (e.g., that no termination request has been received), control of the machine-readable instructions and/or operations 1400 of FIG. 14 returns to Block 1402. If the processor circuitry of the controller 130 instead determines at Block 1410 that the second fuel level sensor control process and/or protocol of FIG. 14 is to cease or terminate (e.g., that a termination request has been received), the machine-readable instructions and/or operations 1400 of FIG. 14 end.

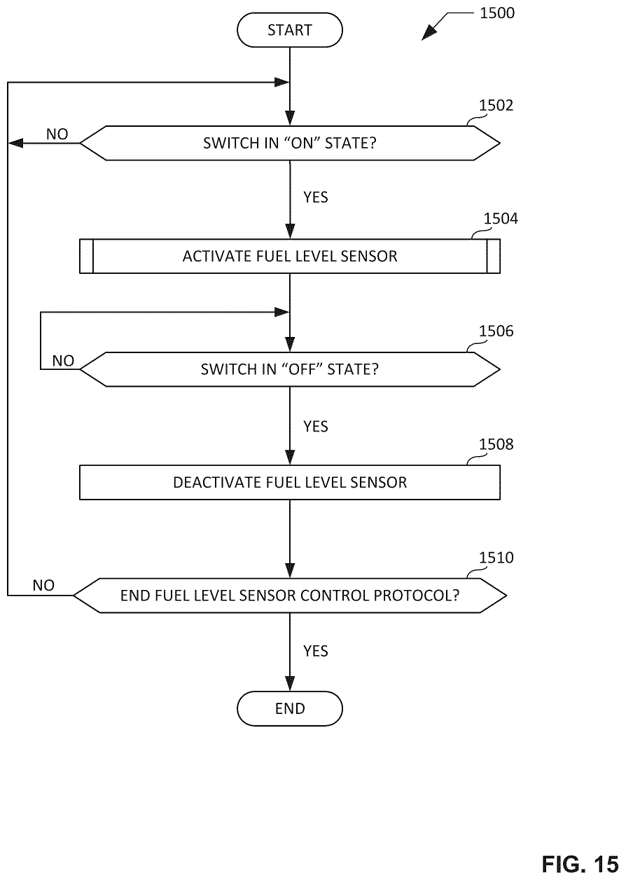

FIG. 15 is a flowchart representative of example machine-readable instructions and/or example operations 1500 that may be executed by processor circuitry (e.g., processor circuitry of the controller 130 of FIG. 1) to implement a third fuel level sensor control process via the pellet grill 100 of FIG. 1. The machine-readable instructions and/or operations 1500 of FIG. 15 begin at Block 1502 when the processor circuitry of the controller 130 of FIG. 1 determines whether the switch 116 of the pellet grill 100 of FIG. 1 is in an ON state (e.g., closed and/or in a powered state). For example, the processor circuitry of the controller 130 can determine, based on data sensed, measured, and/or detected by the state sensor 118 of FIG. 1, that the switch 116 of the pellet grill 100 is in an ON state. If the processor circuitry of the controller 130 determines at Block 1502 that the switch 116 of the pellet grill 100 is in an ON state, control of the machine-readable instructions and/or operations 1500 of FIG. 15 proceeds to Block 1504. If the processor circuitry of the controller 130 instead determines at Block 1502 that the switch 116 of the pellet grill 100 is not in an ON state, control of the machine-readable instructions and/or operations 1500 of FIG. 15 remains at Block 1502.

At Block 1504, the processor circuitry of the controller 130 of FIG. 1 commands, instructs, signals, and/or otherwise causes the fuel level sensor 114 of FIG. 1 to activate (e.g., to begin operating). Various fuel level sensor activation subroutines that can be implemented by the processor circuitry of the controller 130 of FIG. 1 in connection with performing and/or executing Block 1504 of the third fuel level sensor control process 1500 of FIG. 15 are described below in connection with FIGS. 17-18. Following Block 1504, control of the machine-readable instructions and/or operations 1500 of FIG. 15 proceeds to Block 1506.

At Block 1506, the processor circuitry of the controller 130 of FIG. 1 determines whether the switch 116 of the pellet grill 100 of FIG. 1 is in an OFF state (e.g., open and/or in an unpowered state). For example, the processor circuitry of the controller 130 can determine, based on data sensed, measured, and/or detected by the state sensor 118 of FIG. 1, that the switch 116 of the pellet grill 100 is in an OFF state. If the processor circuitry of the controller 130 determines at Block 1506 that the switch 116 of the pellet grill 100 is in an OFF state, control of the machine-readable instructions and/or operations 1500 of FIG. 15 proceeds to Block 1508. If the processor circuitry of the controller 130 instead determines at Block 1506 that the switch 116 of the pellet grill 100 is not in an OFF state, control of the machine-readable instructions and/or operations 1500 of FIG. 15 remains at Block 1506.

At Block 1508, the processor circuitry of the controller 130 of FIG. 1 commands, instructs, signals, and/or otherwise causes the fuel level sensor 114 of FIG. 1 to deactivate (e.g., to cease operating). Following Block 1508, control of the machine-readable instructions and/or operations 1500 of FIG. 15 proceeds to Block 1510.

At Block 1510, the processor circuitry of the controller 138 of FIG. 1 determines whether to end the third fuel level sensor control process and/or protocol set forth in FIG. 15. For example, the processor circuitry of the controller 130 can determine whether the user interface 120 and/or the network interface 126 of the control system 102 of FIG. 1 has/have received any commands, instructions, signals, inputs, and/or other data indicative of a request to terminate the third fuel level sensor control process and/or protocol of FIG. 15. If the processor circuitry of the controller 130 determines at Block 1510 that the third fuel level sensor control process and/or protocol of FIG. 15 is to continue (e.g., that no termination request has been received), control of the machine-readable instructions and/or operations 1500 of FIG. 15 returns to Block 1502. If the processor circuitry of the controller 130 instead determines at Block 1510 that the third fuel level sensor control process and/or protocol of FIG. 15 is to cease or terminate (e.g., that a termination request has been received), the machine-readable instructions and/or operations 1500 of FIG. 15 end.

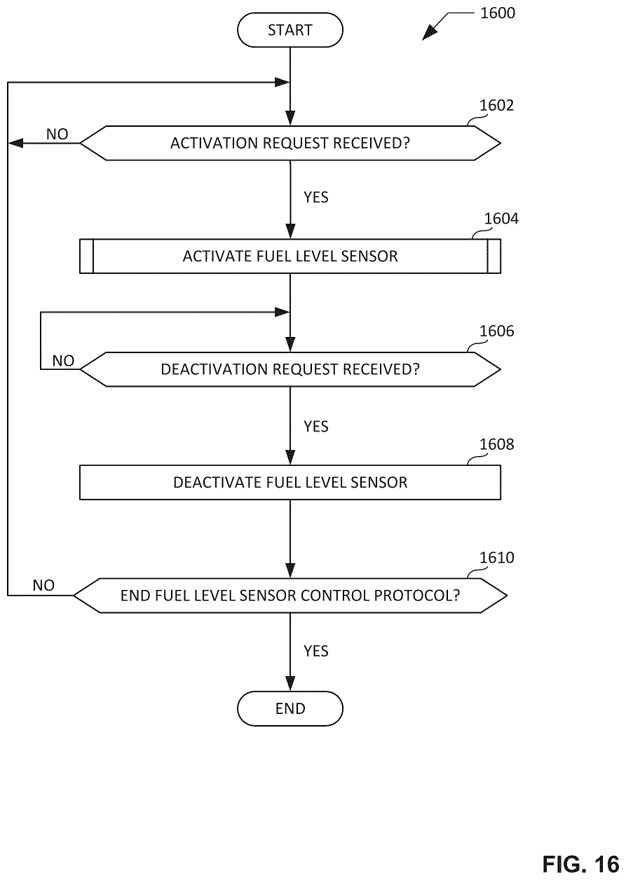

FIG. 16 is a flowchart representative of example machine-readable instructions and/or example operations 1600 that may be executed by processor circuitry (e.g., processor circuitry of the controller 130 of FIG. 1) to implement a fourth fuel level sensor control process via the pellet grill 100 of FIG. 1. The machine-readable instructions and/or operations 1600 of FIG. 16 begin at Block 1602 when the processor circuitry of the controller 130 of FIG. 1 determines whether the control system 102 of the pellet grill 100 of FIG. 1 has received an activation request associated with the fuel level sensor 114 of the pellet grill 100 of FIG. 1. For example, the processor circuitry of the controller 130 can determine whether the user interface 120 and/or the network interface 126 of the control system 102 of FIG. 1 has/have received any commands, instructions, signals, inputs, and/or other data indicative of a request to activate the fuel level sensor 114 of the pellet grill 100. If the processor circuitry of the controller 130 determines at Block 1602 that the control system 102 of the pellet grill 100 has received an activation request associated with the fuel level sensor 114 of the pellet grill 100, control of the machine-readable instructions and/or operations 1600 of FIG. 16 proceeds to Block 1604. If the processor circuitry of the controller 130 instead determines at Block 1602 that the control system 102 of the pellet grill 100 has not received an activation request associated with the fuel level sensor 114 of the pellet grill 100, control of the machine-readable instructions and/or operations 1600 of FIG. 16 remains at Block 1602.

At Block 1604, the processor circuitry of the controller 130 of FIG. 1 commands, instructs, signals, and/or otherwise causes the fuel level sensor 114 of FIG. 1 to activate (e.g., to begin operating). Various fuel level sensor activation subroutines that can be implemented by the processor circuitry of the controller 130 of FIG. 1 in connection with performing and/or executing Block 1604 of the fourth fuel level sensor control process 1600 of FIG. 16 are described below in connection with FIGS. 17-18. Following Block 1604, control of the machine-readable instructions and/or operations 1600 of FIG. 16 proceeds to Block 1606.

At Block 1606, the processor circuitry of the controller 130 of FIG. 1 determines whether the control system 102 of the pellet grill 100 of FIG. 1 has received a deactivation request associated with the fuel level sensor 114 of the pellet grill 100 of FIG. 1. For example, the processor circuitry of the controller 130 can determine whether the user interface 120 and/or the network interface 126 of the control system 102 of FIG. 1 has/have received any commands, instructions, signals, inputs, and/or other data indicative of a request to deactivate the fuel level sensor 114 of the pellet grill 100. If the processor circuitry of the controller 130 determines at Block 1606 that the control system 102 of the pellet grill 100 has received a deactivation request associated with the fuel level sensor 114 of the pellet grill 100, control of the machine-readable instructions and/or operations 1600 of FIG. 16 proceeds to Block 1608. If the processor circuitry of the controller 130 instead determines at Block 1606 that the control system 102 of the pellet grill 100 has not received a deactivation request associated with the fuel level sensor 114 of the pellet grill 100, control of the machine-readable instructions and/or operations 1600 of FIG. 16 remains at Block 1606.

At Block 1608, the processor circuitry of the controller 130 of FIG. 1 commands, instructs, signals, and/or otherwise causes the fuel level sensor 114 of FIG. 1 to deactivate (e.g., to cease operating). Following Block 1608, control of the machine-readable instructions and/or operations 1600 of FIG. 16 proceeds to Block 1610.

At Block 1610, the processor circuitry of the controller 130 of FIG. 1 determines whether to end the fourth fuel level sensor control process and/or protocol set forth in FIG. 16. For example, the processor circuitry of the controller 130 can determine whether the user interface 120 and/or the network interface 126 of the control system 102 of FIG. 1 has/have received any commands, instructions, signals, inputs, and/or other data indicative of a request to terminate the fourth fuel level sensor control process and/or protocol of FIG. 16. If the processor circuitry of the controller 130 determines at Block 1610 that the fourth fuel level sensor control process and/or protocol of FIG. 16 is to continue (e.g., that no termination request has been received), control of the machine-readable instructions and/or operations 1600 of FIG. 16 returns to Block 1602. If the processor circuitry of the controller 130 instead determines at Block 1610 that the fourth fuel level sensor control process and/or protocol of FIG. 16 is to cease or terminate (e.g., that a termination request has been received), the machine-readable instructions and/or operations 1600 of FIG. 16 end.

FIG. 17 is a flowchart representative of example machine-readable instructions and/or example operations 1700 that may be executed by processor circuitry (e.g., processor circuitry of the controller 130 of FIG. 1) to implement a first fuel level sensor activation subroutine via the pellet grill 100 of FIG. 1. Example machine-readable instructions and/or operations of Block 1702, Block 1704, Block 1706, and Block 1708 of FIG. 17 can be used to implement Block 1304 of the first fuel level sensor control process 1300 of FIG. 13, Block 1404 of the second fuel level sensor control process 1400 of FIG. 14, Block 1504 of the third fuel level sensor control process 1500 of FIG. 15, and/or Block 1604 of the fourth fuel level sensor control process 1600 of FIG. 16. The machine-readable instructions and/or operations 1700 of FIG. 17 begin at Block 1702 when the fuel level sensor 114 of FIG. 1 transmits infrared light toward pellet fuel located in the pellet fuel storage compartment 502 of the hopper 212 of the pellet grill 100 of FIG. 1. For example, the transmission portion 1002 of the fuel level sensor 114 (e.g., an infrared transmitter of a time-of-flight sensor) can transmit and/project infrared light from the fuel level sensor 114 toward pellet fuel (e.g., wood or charcoal pellets) located within the pellet fuel storage compartment 502 of the hopper 212 of the pellet grill 100. In some examples, the infrared light transmitted from the transmission portion 1002 of the fuel level sensor 114 toward the pellet fuel passes through the first lens 706 of the cover 700 of the fuel level sensor 114 before reaching the pellet fuel, with the transmitted infrared light passing through the first lens 706 of the cover 700 on the first side 712 of the divider 710 of the cover 700. Following Block 1702, control of the machine-readable instructions and/or operations 1700 of FIG. 17 proceeds to Block 1704.

At Block 1704, the fuel level sensor 114 of FIG. 1 receives infrared light reflected from the pellet fuel located in the pellet fuel storage compartment 502 of the hopper 212 of the pellet grill 100 of FIG. 1. For example, the detection portion 1004 of the fuel level sensor 114 (e.g., an infrared receiver of a time-of-flight sensor) can receive infrared light reflected from the pellet fuel (e.g., the wood or charcoal pellets) located within the pellet fuel storage compartment 502 of the hopper 212 of the pellet grill 100 back toward the detection portion 1004. In some examples, the reflected infrared light passes through the second lens 708 of the cover 700 of the fuel level sensor 114 prior to being received at the detection portion 1004 of the fuel level sensor 114, with the reflected infrared light passing through the second lens 708 of the cover 700 on the second side 714 of the divider 710 of the cover 700 located opposite the first side 712 of the divider 710 of the cover 700. Following Block 1704, control of the machine-readable instructions and/or operations 1700 of FIG. 17 proceeds to Block 1706.

At Block 1706, the processor circuitry of the controller 130 of FIG. 1 determines a level or an amount of pellet fuel present in the pellet fuel storage compartment 502 of the hopper 212 of the pellet grill 100 (referenced herein as the “fuel level”) based on the infrared light received at the fuel level sensor 114 of FIG. 1. For example, the processor circuitry of the controller 130 can determine the fuel level by accessing correlation data that identifies and/or otherwise indicates a fuel level corresponding to the sensed, measured, and/or detected timing (e.g., time of travel) and/or amount (e.g., quantity) of infrared light (e.g., reflected from the pellet fuel) received at the detection portion 1004 of the fuel level sensor 114. Following Block 1706, control of the machine-readable instructions and/or operations 1700 of FIG. 17 proceeds to Block 1708.

At Block 1708, the processor circuitry of the controller 130 of FIG. 1 instructs, commands, signals, and/or otherwise causes one or more notification(s) associated with the determined fuel level to be presented locally and/or remotely. For example, the processor circuitry of the controller 130 can instruct, command, signal, and/or otherwise cause the user interface 120 of the pellet grill 100 of FIG. 1 to locally present (e.g., via one or more of the output device(s) 124 of the user interface 120) one or more notification(s) identifying and/or otherwise indicating the determined fuel level. As another example, the processor circuitry of the controller 130 can additionally or alternatively instruct, command, signal, and/or otherwise cause the network interface 126 of the pellet grill 100 of FIG. 1 to transmit (e.g., via one or more of the communication device(s) 128 of the network interface 126) one or more notification(s) identifying and/or otherwise indicating the determined fuel level to one or more of the remote device(s) 136 of FIG. 1 for remote presentation via one or more of the output device(s) of the remote device(s) 136. In some examples, one or more of the notification(s) identifying and/or otherwise indicating the determined fuel level of the pellet grill 100 can be expressed (e.g., textually, graphically, visually, and/or audibly represented) as a percentage of a maximum capacity (e.g., the fuel level is at 80% of the maximum capacity, the fuel level is 50% of the maximum capacity, etc.). In other examples, one or more of the notification(s) identifying and/or otherwise indicating the determined fuel level of the pellet grill 100 can be expressed (e.g., textually, graphically, visually, and/or audibly represented) in more relative and/or more general terms (e.g., the fuel level is high, the fuel level is low, etc.). Following Block 1708, control of the machine-readable instructions and/or operations 1700 of FIG. 17 returns to Block 1702.

The processor circuitry of the controller 130 of FIG. 1 implements the machine-readable instructions and/or operations 1700 of FIG. 17 described above (e.g., including Block 1702, Block 1704, Block 1706, and Block 1708) as a looped control function or subroutine, with such implementation continuing until a deactivation triggering event detected by the control system 102 of the pellet grill 100 dictates otherwise (e.g., detection of the control system 102 of the pellet grill 100 being in or transitioning into an OFF state, detection of the control system 102 of the pellet grill 100 initiating a shutdown sequence, detection of the switch 116 of the pellet grill 100 being in or transitioning into an OFF state, detection that the control system 102 of the pellet grill 100 has received a deactivation request associated with the fuel level sensor 114, etc.).

FIG. 18 is a flowchart representative of example machine-readable instructions and/or example operations 1800 that may be executed by processor circuitry (e.g., processor circuitry of the controller 130 of FIG. 1) to implement a second fuel level sensor activation subroutine via the pellet grill 100 of FIG. 1. Example machine-readable instructions and/or operations of Block 1802, Block 1804, Block 1806, Block 1808, and Block 1810 of FIG. 18 can be used to implement Block 1304 of the first fuel level sensor control process 1300 of FIG. 13, Block 1404 of the second fuel level sensor control process 1400 of FIG. 14, Block 1504 of the third fuel level sensor control process 1500 of FIG. 15, and/or Block 1604 of the fourth fuel level sensor control process 1600 of FIG. 16. The machine-readable instructions and/or operations 1800 of FIG. 18 begin at Block 1802 when the fuel level sensor 114 of FIG. 1 transmits infrared light toward pellet fuel located in the pellet fuel storage compartment 502 of the hopper 212 of the pellet grill 100 of FIG. 1. For example, the transmission portion 1002 of the fuel level sensor 114 (e.g., an infrared transmitter of a time-of-flight sensor) can transmit and/project infrared light from the fuel level sensor 114 toward pellet fuel (e.g., wood or charcoal pellets) located within the pellet fuel storage compartment 502 of the hopper 212 of the pellet grill 100. In some examples, the infrared light transmitted from the transmission portion 1002 of the fuel level sensor 114 toward the pellet fuel passes through the first lens 706 of the cover 700 of the fuel level sensor 114 before reaching the pellet fuel, with the transmitted infrared light passing through the first lens 706 of the cover 700 on the first side 712 of the divider 710 of the cover 700. Following Block 1802, control of the machine-readable instructions and/or operations 1800 of FIG. 18 proceeds to Block 1804.

At Block 1804, the fuel level sensor 114 of FIG. 1 receives infrared light reflected from the pellet fuel located in the pellet fuel storage compartment 502 of the hopper 212 of the pellet grill 100 of FIG. 1. For example, the detection portion 1004 of the fuel level sensor 114 (e.g., an infrared receiver of a time-of-flight sensor) can receive infrared light reflected from the pellet fuel (e.g., the wood or charcoal pellets) located within the pellet fuel storage compartment 502 of the hopper 212 of the pellet grill 100 back toward the detection portion 1004. In some examples, the reflected infrared light passes through the second lens 708 of the cover 700 of the fuel level sensor 114 prior to being received at the detection portion 1004 of the fuel level sensor 114, with the reflected infrared light passing through the second lens 708 of the cover 700 on the second side 714 of the divider 710 of the cover 700 located opposite the first side 712 of the divider 710 of the cover 700. Following Block 1804, control of the machine-readable instructions and/or operations 1800 of FIG. 18 proceeds to Block 1806.

At Block 1806, the processor circuitry of the controller 130 of FIG. 1 determines a level or an amount of pellet fuel present in the pellet fuel storage compartment 502 of the hopper 212 of the pellet grill 100 (referenced herein as the “fuel level”) based on the infrared light received at the fuel level sensor 114 of FIG. 1. For example, the processor circuitry of the controller 130 can determine the fuel level by accessing correlation data that identifies and/or otherwise indicates a fuel level corresponding to the sensed, measured, and/or detected timing (e.g., time of travel) and/or amount (e.g., quantity) of infrared light (e.g., reflected from the pellet fuel) received at the detection portion 1004 of the fuel level sensor 114. Following Block 1806, control of the machine-readable instructions and/or operations 1800 of FIG. 18 proceeds to Block 1808.

At Block 1808, the processor circuitry of the controller 130 of FIG. 1 evaluates whether the determined fuel level is below one or more fuel level threshold(s). For example, the processor circuitry of the controller 130 can compare the fuel level determined at Block 1806 to a first fuel level threshold corresponding to the pellet fuel storage compartment 502 of the hopper 212 being occupied with pellet fuel by a first threshold amount (e.g., 50% of the compartment). As another example, the processor circuitry of the controller 130 can compare the fuel level determined at Block 1806 to a second fuel level threshold corresponding to the pellet fuel storage compartment 502 of the hopper 212 being occupied with pellet fuel by a second threshold amount (e.g., 25% of the compartment) that differs from the first threshold amount. If the processor circuitry of the controller 130 determines at Block 1808 that the determined fuel level is below at least one of the one or more fuel level threshold(s), control of the machine-readable instructions and/or operations 1800 of FIG. 18 proceeds to Block 1810. If the processor circuitry of the controller 130 instead determines at Block 1808 that the determined fuel level is not below any of the one or more fuel level threshold(s), control of the machine-readable instructions and/or operations 1800 of FIG. 18 returns to Block 1802.

At Block 1810, the processor circuitry of the controller 130 of FIG. 1 instructs, commands, signals, and/or otherwise causes one or more notification(s) associated with the determined fuel level to be presented locally and/or remotely. For example, the processor circuitry of the controller 130 can instruct, command, signal, and/or otherwise cause the user interface 120 of the pellet grill 100 of FIG. 1 to locally present (e.g., via one or more of the output device(s) 124 of the user interface 120) one or more notification(s) identifying and/or otherwise indicating the determined fuel level. As another example, the processor circuitry of the controller 130 can additionally or alternatively instruct, command, signal, and/or otherwise cause the network interface 126 of the pellet grill 100 of FIG. 1 to transmit (e.g., via one or more of the communication device(s) 128 of the network interface 126) one or more notification(s) identifying and/or otherwise indicating the determined fuel level to one or more of the remote device(s) 136 of FIG. 1 for remote presentation via one or more of the output device(s) of the remote device(s) 136. In some examples, one or more of the notification(s) identifying and/or otherwise indicating the determined fuel level of the pellet grill 100 can be expressed (e.g., textually, graphically, visually, and/or audibly represented) as a percentage of a maximum capacity (e.g., the fuel level is at 80% of the maximum capacity, the fuel level is 50% of the maximum capacity, etc.). In other examples, one or more of the notification(s) identifying and/or otherwise indicating the determined fuel level of the pellet grill 100 can be expressed (e.g., textually, graphically, visually, and/or audibly represented) in more relative and/or more general terms (e.g., the fuel level is high, the fuel level is low, etc.). In still other examples, one or more of the notification(s) identifying and/or otherwise indicating the determined fuel level of the pellet grill 100 can express (e.g., textually, graphically, visually, and/or audibly represent) that the determined fuel level is below at least one of the one or more fuel level threshold(s). Following Block 1810, control of the machine-readable instructions and/or operations 1800 of FIG. 18 returns to Block 1802.

The processor circuitry of the controller 130 of FIG. 1 implements the machine-readable instructions and/or operations 1800 of FIG. 18 described above (e.g., including Block 1802, Block 1804, Block 1806, Block 1808, and Block 1810) as a looped control function or subroutine, with such implementation continuing until a deactivation triggering event detected by the control system 102 of the pellet grill 100 dictates otherwise (e.g., detection of the control system 102 of the pellet grill 100 being in or transitioning into an OFF state, detection of the control system 102 of the pellet grill 100 initiating a shutdown sequence, detection of the switch 116 of the pellet grill 100 being in or transitioning into an OFF state, detection that the control system 102 of the pellet grill 100 has received a deactivation request associated with the fuel level sensor 114, etc.).

FIG. 19 is a block diagram of an example processor platform 1900 including processor circuitry structured to execute and/or instantiate the machine-readable instructions and/or operations of FIGS. 13-18 to implement the pellet grill 100 of FIG. 1. The processor platform 1900 of the illustrated example includes processor circuitry 1902. The processor circuitry 1902 of the illustrated example is hardware. For example, the processor circuitry 1902 includes any type(s) and/or any number(s) of processor(s), microprocessor(s), controller(s), microcontroller(s), ASIC(s), PLD(s), FPLD(s), FPGA(s), DSP(s), GPU(s), CPU(s), semiconductor-based (e.g., silicon-based) circuit(s), digital circuit(s), analog circuit(s), logic circuit(s), and/or integrated circuit(s) implemented by any type(s) and/or any number(s) of transistor(s), capacitor(s), diode(s), inductor(s), resistor(s), timer(s), counter(s), printed circuit board(s), connector(s), wire(s), and/or other electrical circuit component(s). In this example, the processor circuitry 1902 implements the controller 130 of FIG. 1.

The processor circuitry 1902 of the illustrated example includes a local memory 1904 (e.g., a cache, registers, etc.). The processor circuitry 1902 is in electrical communication with a main memory via a bus 1906, with the main memory including a volatile memory 1908 and a non-volatile memory 1910. The volatile memory 1908 may be implemented by any type of random-access memory (RAM) (e.g., Synchronous Dynamic Random Access Memory (SDRAM), Dynamic Random Access Memory (DRAM), RAMBUS® Dynamic Random Access Memory (RDRAM®), etc.). The non-volatile memory 1910 may be implemented by flash memory and/or any other desired type of memory device. Access to the main memory 1908, 1910 of the illustrated example is controlled by a memory controller 1912.

The processor platform 1900 of the illustrated example also includes one or more mass storage device(s) 1914 to store software and/or data. Examples of such mass storage device(s) 1914 include an optical storage device, a magnetic storage device, a floppy disk drive, a hard disk drive (HDD), a solid state storage device, a flash memory device, a read-only memory (ROM), a random-access memory (RAM), a cache, a CD, a DVD, a Blu-ray disk, and/or any other tangible storage device or tangible storage disk in which information is stored for any duration (e.g., permanently, for extended time periods, for brief instances, for temporarily buffering, and/or for caching of the information). In the illustrated example of FIG. 19, one or more of the volatile memory 1908, the non-volatile memory 1910, and/or the mass storage device(s) 1914 implement(s) the memory 132 of FIG. 1.

The processor circuitry 1902 is also in electrical communication with one or more sensor(s) 1916 via the bus 1906. In this example, the sensors 1916 include the fuel level sensor 114, the switch 116, and the state sensor 118 of FIG. 1. The processor circuitry 1902 is also in electrical communication with one or more motor(s) 1918 via the bus 1906. In this example, the motors 1918 include the auger motor 108 and the fan 112 of FIG. 1. The processor circuitry 1902 is also in electrical communication with one or more ignitor(s) 1920 via the bus 1906. In this example, the ignitor 1920 includes the ignitor 110 of FIG. 1.

The processor platform 1900 of the illustrated example also includes user interface circuitry 1922. The user interface circuitry 1922 may be implemented by hardware in accordance with any type of interface standard, such as an Ethernet interface, a universal serial bus (USB) interface, a Bluetooth® interface, a near field communication (NFC) interface, a PCI interface, and/or a PCIe interface. In the illustrated example, one or more input device(s) 122 are connected to the user interface circuitry 1922. The input device(s) 122 permit(s) a user to enter data and/or commands into the processor circuitry 1902. The input device(s) 122 can be implemented, for example, by one or more of a touchscreen, a button, a dial, a knob, a switch, an audio sensor, a microphone, an image sensor, a camera, and/or a voice recognition system. One or more output device(s) 124 are also connected to the user interface circuitry 1922 of the illustrated example. The output device(s) 124 can be implemented, for example, by one or more of a display device (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, and/or a speaker. The user interface circuitry 1922 of the illustrated example, thus, typically includes a graphics driver card, a graphics driver chip, and/or graphics processor circuitry such as a GPU. In the illustrated example of FIG. 19, the user interface circuitry 1922, the input device(s) 122, and the output device(s) 124 collectively implement the user interface 120 of FIG. 1.

The processor platform 1900 of the illustrated example also includes network interface circuitry 1924. The network interface circuitry 1924 includes one or more communication device(s) (e.g., transmitter(s), receiver(s), transceiver(s), modem(s), gateway(s), wireless access point(s), etc.) to facilitate exchange of data with external machines (e.g., computing devices of any kind, including the remote device(s) 136 of FIG. 1) by a network 1926. The communication can be by, for example, a satellite system, a wireless system, a cellular telephone system, an Ethernet connection, a digital subscriber line (DSL) connection, a telephone line connection, a coaxial cable system, an optical connection, etc. In the illustrated example of FIG. 19, the network interface circuitry 1924 implements the network interface 126 (e.g., including the communication device(s) 128) of FIG. 1.

Coded instructions 1928 including the above-described machine-readable instructions and/or operations of FIGS. 13-18 may be stored in the local memory 1904, in the volatile memory 1908, in the non-volatile memory 1910, on the mass storage device(s) 1914, and/or on a removable non-transitory computer-readable storage medium such as a flash memory stick, a dongle, a CD, a DVD, or a Blu-ray disk.

The following paragraphs provide various examples in relation to the disclosed fuel level sensors for hoppers of pellet grills.

Example 1 includes a pellet grill. In Example 1, the pellet grill includes a hopper, a fuel level sensor, and a cover. The hopper includes a pellet fuel storage compartment. In Example 1, the fuel level sensor includes a transmission portion and a detection portion. The transmission portion is configured to transmit infrared light toward pellet fuel located within the pellet fuel storage compartment. The detection portion is configured to receive infrared light reflected from the pellet fuel toward the detection portion. In Example 1, the cover includes a first lens, a second lens, and a divider. The first lens and the second lens are located between the fuel level sensor and the pellet fuel. The divider is located between the first lens and the second lens. The divider has a first side and a second side located opposite the first side. Infrared light transmitted from the transmission portion toward the pellet fuel passes through the first lens on the first side of the divider. Infrared light reflected from the pellet fuel toward the detection portion passes through the second lens on the second side of the divider.

Example 2 includes the pellet grill of Example 1. In Example 2, the transmission portion of the fuel level sensor is located on the first side of the divider, and the detection portion of the fuel level sensor is located on the second side of the divider.

Example 3 includes the pellet grill of Example 2. In Example 3, the cover further includes a first compartment located on the first side of the divider, and a second compartment located on the second side of the divider. In Example 3, the transmission portion of the fuel level sensor is aligned with the first compartment, and the detection portion of the fuel level sensor is aligned with the second compartment.

Example 4 includes the pellet grill of Example 3. In Example 4, the transmission portion includes an infrared transmitter and the detection portion includes an infrared receiver. In Example 4, the infrared transmitter and the infrared receiver are components of a time-of-flight sensor.

Example 5 includes the pellet grill of Example 1. In Example 5, the first lens and the second lens are configured to shield the fuel level sensor from particulate or wear.

Example 6 includes the pellet grill of Example 1. In Example 6, the divider is configured to reduce crosstalk associated with infrared light transmitted from the transmission portion.

Example 7 includes the pellet grill of Example 1. In Example 7, the pellet grill further comprises a printed circuit board assembly (PCBA) including a printed circuit board (PCB), the fuel level sensor, and the cover. In Example 7, the fuel level sensor is positioned between the PCB and one or more of the first lens and the second lens of the cover.

Example 8 includes the pellet grill of Example 7. In Example 8, the PCBA is located along an interior wall that defines the pellet fuel storage compartment of the hopper.

Example 9 includes the pellet grill of Example 1. In Example 9, the pellet grill further comprises a controller configured to determine a fuel level of the pellet fuel based on a time of travel or a quantity associated with infrared light received at the detection portion of the fuel level sensor.

Example 10 includes the pellet grill of Example 9. In Example 10, the controller is further configured to cause a notification associated with the determined fuel level to be presented locally or remotely relative to the pellet grill.

Example 11 includes the pellet grill of Example 9. In Example 11, the controller is further configured to evaluate whether the determined fuel level of the pellet fuel is below a fuel level threshold.

Example 12 includes the pellet grill of Example 11. In Example 12, the controller is configured, in response to detecting that the determined fuel level is below the fuel level threshold, to cause a notification associated with the determined fuel level or the fuel level threshold to be presented locally or remotely relative to the pellet grill.

Example 13 includes the pellet grill of Example 9. In Example 13, the controller is further configured to activate the fuel level sensor in response to detecting an occurrence of an activation triggering event.

Example 14 includes the pellet grill of Example 13. In Example 14, detecting the occurrence of the activation triggering event includes determining that a control system of the pellet grill is in an ON state or that the control system has initiated a startup sequence.

Example 15 includes the pellet grill of Example 13. In Example 15, detecting the occurrence of the activation triggering event includes determining that a switch of the pellet grill is in an ON state.

Example 16 includes the pellet grill of Example 13. In Example 16, detecting the occurrence of the activation triggering event includes determining that a fuel level sensor activation request has been received via a user interface or a network interface of the pellet grill.

Example 17 includes the pellet grill of Example 13. In Example 17, the controller is further configured to deactivate the fuel level sensor in response to detecting an occurrence of a deactivation triggering event.

Example 18 includes the pellet grill of Example 17. In Example 18, detecting the occurrence of the deactivation triggering event includes determining that a control system of the pellet grill is in an OFF state or that the control system has initiated a shutdown sequence.

Example 19 includes the pellet grill of Example 17. In Example 19, detecting the occurrence of the deactivation triggering event includes determining that a switch of the pellet grill is in an OFF state.

Example 20 includes the pellet grill of Example 17. In Example 20, detecting the occurrence of the deactivation triggering event includes determining that a fuel level sensor deactivation request has been received via a user interface or a network interface of the pellet grill.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. A pellet grill, comprising:
a hopper including a pellet fuel storage compartment;
a fuel level sensor including a transmission portion and a detection portion, the transmission portion configured to transmit infrared light toward pellet fuel located within the pellet fuel storage compartment, the detection portion configured to receive infrared light reflected from the pellet fuel toward the detection portion; and
a cover including a first lens, a second lens, and a divider, the first lens and the second lens located between the fuel level sensor and the pellet fuel, the divider located between the first lens and the second lens, the divider having a first side and a second side located opposite the first side, wherein infrared light transmitted from the transmission portion toward the pellet fuel passes through the first lens on the first side of the divider, and wherein infrared light reflected from the pellet fuel toward the detection portion passes through the second lens on the second side of the divider.

2. The pellet grill of claim 1, wherein the transmission portion of the fuel level sensor is located on the first side of the divider, and the detection portion of the fuel level sensor is located on the second side of the divider.

3. The pellet grill of claim 2, wherein the cover further includes a first compartment located on the first side of the divider and a second compartment located on the second side of the divider, wherein the transmission portion of the fuel level sensor is aligned with the first compartment and the detection portion of the fuel level sensor is aligned with the second compartment.

4. The pellet grill of claim 3, wherein the transmission portion includes an infrared transmitter and the detection portion includes an infrared receiver, wherein the infrared transmitter and the infrared receiver are components of a time-of-flight sensor.

5. The pellet grill of claim 1, wherein the first lens and the second lens are configured to shield the fuel level sensor from particulate or wear.

6. The pellet grill of claim 1, wherein the divider is configured to reduce crosstalk associated with infrared light transmitted from the transmission portion.

7. The pellet grill of claim 1, further comprising a printed circuit board assembly (PCBA) including a printed circuit board (PCB), the fuel level sensor, and the cover, wherein the fuel level sensor is positioned between the PCB and one or more of the first lens and the second lens of the cover.

8. The pellet grill of claim 7, wherein the PCBA is located along an interior wall that defines the pellet fuel storage compartment of the hopper.

9. The pellet grill of claim 1, further comprising a controller configured to determine a fuel level of the pellet fuel based on a time of travel or a quantity associated with infrared light received at the detection portion of the fuel level sensor.

10. The pellet grill of claim 9, wherein the controller is configured to cause a notification associated with the determined fuel level to be presented locally or remotely relative to the pellet grill.

11. The pellet grill of claim 9, wherein the controller is further configured to evaluate whether the determined fuel level of the pellet fuel is below a fuel level threshold.

12. The pellet grill of claim 11, wherein the controller is configured, in response to detecting that the determined fuel level is below the fuel level threshold, to cause a notification associated with the determined fuel level or the fuel level threshold to be presented locally or remotely relative to the pellet grill.

13. The pellet grill of claim 9, wherein the controller is further configured to activate the fuel level sensor in response to detecting an occurrence of an activation triggering event.

14. The pellet grill of claim 13, wherein detecting the occurrence of the activation triggering event includes determining that a control system of the pellet grill is in an ON state or that the control system has initiated a startup sequence.

15. The pellet grill of claim 13, wherein detecting the occurrence of the activation triggering event includes determining that a switch of the pellet grill is in an ON state.

16. The pellet grill of claim 13, wherein detecting the occurrence of the activation triggering event includes determining that a fuel level sensor activation request has been received via a user interface or a network interface of the pellet grill.

17. The pellet grill of claim 13, wherein the controller is further configured to deactivate the fuel level sensor in response to detecting an occurrence of a deactivation triggering event.

18. The pellet grill of claim 17, wherein detecting the occurrence of the deactivation triggering event includes determining that a control system of the pellet grill is in an OFF state or that the control system has initiated a shutdown sequence.

19. The pellet grill of claim 17, wherein detecting the occurrence of the deactivation triggering event includes determining that a switch of the pellet grill is in an OFF state.

20. The pellet grill of claim 17, wherein detecting the occurrence of the deactivation triggering event includes determining that a fuel level sensor deactivation request has been received via a user interface or a network interface of the pellet grill.
